(19) United States
(12) Patent Application Publication
(10) Pub. No.: US 2020/0051033 A1
(43) Pub. Date: Feb. 13, 2020

(54) AUTOMATED RESUME AND JOB POSTING CREATION WITH LIMITED USER-GENERATED INFORMATION

(71) Applicant: CareerBuilder, LLC, Chicago, IL (US)

(72) Inventors: Mohammed Korayem, Johns Creek, GA (US); Janani Balaji, Cumming, GA (US); Madhav Sigdel, Atlanta, GA (US); Michael Pate, Peach Tree Corners, GA (US); Humair Ghauri, San Ramon, CA (US); Brian Gaspar, Los Gatos, CA (US); Robert Malony, Daytona Beach, FL (US); Carl Eric Presley, Peach Tree Corners, GA (US); Mark Alan Patterson, JR., Brookhaven, GA (US); Faizan Javed, Peach Tree Corners, GA (US)

(21) Appl. No.: 16/534,335

(22) Filed: Aug. 7, 2019

Related U.S. Application Data
(60) Provisional application No. 62/715,699, filed on Aug. 7, 2018.
(60) Provisional application No. 62/786,077, filed on Dec. 28, 2018.

(51) Int. Cl. G06Q 10/10; G06F 17/24

(52) U.S. Cl. CPC G06Q 10/1053; G06F 17/243

(57) ABSTRACT

Method and apparatus are disclosed for automated resume and job posting creation with limited user-generated information. An example automated system includes a database and processor(s). The processor(s) are configured to obtain employment information for previous positions of a candidate via an employment app. For each of the previous positions, the processor(s) are configured to present a position interface; collect an employer name, a position title, a location, and a period of employment via the position interface; present a responsibilities interface that includes suggested responsibilities for the previous position; and collect, via the responsibilities interface, one or more selected responsibilities. The processor(s) are configured to retrieve, for each of the previous positions, the suggested responsibilities from the database based on the employer name, the position title, the location, and the period of employment. The processor(s) are configured to create a resume utilizing the one or more selected responsibilities.

### CROSS-REFERENCE TO RELATED APPLICATIONS

This application claims the benefit of U.S. Provisional Patent Application No. 62/715,699, which was filed on Aug. 7, 2018, and U.S. Provisional Patent Application No. 62/786,077, which was filed on Dec. 28, 2018, both of which are incorporated by reference in their entireties.

### TECHNICAL FIELD

The present disclosure generally relates to resumes and, more specifically, to automated resume and job posting creation with limited user-generated information.

### BACKGROUND

Typically, employment websites (e.g., CareerBuilder.com®) are utilized by employers and job seekers. Oftentimes, an employment website incorporates a job board on which employers may post positions they are seeking to fill. In some instances, the job board enables an employer to include duties of a position and/or desired or required qualifications of job seekers for the position. Additionally, the employment website may enable a job seeker to search through positions posted on the job board. If the job seeker identifies a position of interest, the employment website may provide an application to the job seeker for the job seeker to fill out and submit to the employer via the employment website.

An employment website may provide assistance to job seekers looking for employment. For instance, the employment website may provide tips on navigating their website, advice on conducting interviews, example cover letters, resume templates, etc. Some job seekers potentially still may have difficulty in conducting the job seeking process due to its overwhelming nature. For instance, even with a template in hand, a job seeker potentially may find it difficult to effectively convey their work experience in a resume in a manner that is attractive to employers as a result of forgetting some of the tasks they performed over time and/or not knowing how to describe the tasks they performed in a resume. In turn, a job seeker may (1) spend an inordinate amount of time drafting a resume, (2) draft a resume that does not reflect their work experience, (3) draft a resume that is unattractive to employers, or (4) give up upon being overwhelmed by the drafting process. Thus, there is a need for a user-friendly computer interface that quickly creates a resume representative of a job seeker's experience based on limited user-generated information in a manner that is attractive to potential employers.

Similarly, an employment website may provide assistance to employers looking for employees. For instance, the employment website may provide general instructions on which type of information (e.g., employer name, location, wages, etc.) is to be included in a job posting. Some employers potentially still may have difficulty in attracting the types of candidates that are desired. For instance, an employer may receive an overwhelming number of resumes from under- or overqualified job seekers for the job posting due to, at least in part, how the position was described in the job posting. In turn, an employer may (1) spend an inordinate amount of time reading the resume of all job seekers, (2) unintentionally skip over a qualified candidate in a sea of unqualified candidates, or (3) give up upon being overwhelmed by the process. Thus, there is a need for a user-friendly computer interface that quickly creates a job posting that is representative of the corresponding position based on limited user-generated information in a manner that attracts qualified candidates.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for automated resume and job posting creation with limited user-generated information. An example disclosed automated system for creating resumes for candidates with limited candidate-generated information includes a responsibility database configured to store responsibilities for employment positions of employers. The example disclosed automated system also includes one or more processors configured to obtain employment information for previous positions of a candidate via an employment app. To obtain the employment information for each of the previous positions, the one or more processors are configured to present a position interface of the employment app to the candidate and collect an employer name, a position title, a location, and a period of employment for the previous position of the candidate via the position interface. To obtain the employment information for each of the previous positions, the one or more processors also are configured to retrieve suggested responsibilities in real-time from the responsibility database based on the employer name, the position title, the location, and the period of employment. To obtain the employment information for each of the previous positions, the one or more processors also are configured to present a responsibilities interface of the employment app. The responsibilities interface includes the suggested responsibilities identified for the previous position. To obtain the employment information for each of the previous positions, the one or more processors also are configured to collect, via the responsibilities interface, one or more selected responsibilities that the candidate performed for the previous position. The one or more processors also are configured to create, in real-time, a resume for the candidate utilizing the one or more selected responsibilities to reduce an amount of candidate-generated information from which the resume is created.

In some examples, the employment app presented by the one or more processors includes at least one of a mobile app and a mobile-friendly website for a touchscreen of a mobile device. In some such examples, the employment app includes a plurality of interfaces including the position interface and the responsibilities interface configured to facilitate the one or more processors in quickly collecting the employment information and the selected responsibilities from the candidate.

In some examples, the one or more processors are configured to present the position interface and the responsibilities interface a first time to collect the employment information for a first of the previous positions and subsequently present the position interface and the responsibilities interface a second time to collect the employment information for a second of the previous positions. In some examples, the one or more processors are configured to format the resume into a pdf document in a standard paper size and present a resume interface that includes the resume to enable the candidate to review formatting of the resume.

In some examples, the one or more processors are further configured to construct the responsibilities database and organize links between the responsibilities and the employment positions of the employers within the responsibilities database. In some such examples, to construct the responsibilities database, the one or more processors are configured to collect historical postings from a network and identify posted titles and posted responsibilities within the historical postings. To construct the responsibilities database, the one or more processors also are configured to, for each of the posted titles, utilize parts-of-speech tags and dependency parse trees to identify employment responsibilities of the posted title and, in response to determining that the number of historical postings for the posted title is less than a predetermined threshold, supplement the employment responsibilities with information included in an industry classification system for the posted title. To construct the responsibilities database, the one or more processors also are configured to, for each of the posted titles, rank the employments responsibilities of the posted title for relevancy to enable identification of a predetermined number of the highest ranked employments responsibilities as the suggested responsibilities for the posted title.

In some examples, the suggested responsibilities stored in the responsibility database are modernized from employment responsibilities of historical postings to facilitate the one or more processors in creating the resume to be targeted for current positions. In some examples, the suggested responsibilities stored in the responsibility database are localized based on employment responsibilities of historical postings for different geographic locations to facilitate the one or more processors in creating the resume for a preferred location of the candidate.

In some examples, upon receiving the employer name for one of the previous positions via the position interface, the one or more processors are configured to present a title interface that includes suggested titles for the employer name.

Some examples further include an employer-title database that stores the employer names and the position titles corresponding with the employer names. For one or more of the previous positions, the one or more processors are configured to retrieve the suggested titles based on the employer name.

An example disclosed automated system for creating job postings with limited recruiter-generated information includes a responsibility database configured to store responsibilities for employment positions of employers. The example disclosed automated system also includes one or more processors configured to obtain position information for a posting of a recruiter via an employment app. To obtain the position information, the one or more processors are configured to present a title interface of the employment app to the recruiter, collect a position title for the posting of the recruiter via the position interface, retrieve suggested responsibilities in real-time from the responsibility database based on the position title and a location of the posting, and present a responsibilities interface of the employment app. The responsibilities interface includes the suggested responsibilities identified for the posting. To obtain the position information, the one or more processors also are configured to collect, via the responsibilities interface, one or more selected responsibilities for the posting. The one or more processors also are configured to create, in real-time, a job description for the posting utilizing the one or more selected responsibilities to reduce an amount of recruiter-generated information from which the job description for the posting is created.

In some examples, the suggested responsibilities stored in the responsibility database are modernized and localized based employment responsibilities of historical postings to facilitate the one or more processors in creating the resume to be targeted for current positions.

In some examples, the one or more processors are configured to collect the location for the posting via a location interface of the employment app. In some such examples, the one or more processors are configured to collect an employer name for the posting via an employer interface of the employment app and retrieve the suggested responsibilities from the responsibility database further based on the employer name.

In some examples, the employment app presented by the one or more processors includes at least one of a mobile app and a mobile-friendly website for a touchscreen of a mobile device to facilitate the one or more processors in quickly collecting the position information and the selected responsibilities from the recruiter.

In some examples, the one or more processors are configured to store the job description and the posting in a posting database.

In some examples, the one or more processors are configured to present a position interface of the employment app to the recruiter and receive experience and education information for the posting via the position interface. In such examples, the one or more processors are configured to create the posting further based on the experience and education information.

In some examples, the one or more processors are further configured to construct the responsibilities database and organize links between the responsibilities and the employment positions of the employers within the responsibilities database.

In some such examples, to construct the responsibilities database, the one or more processors are configured to collect historical postings from a network and identify posted titles and posted responsibilities within the historical postings. To construct the responsibilities database, the one or more processors also are configured to, for each of the posted titles, utilize parts-of-speech tags and dependency parse trees to identify employment responsibilities of the posted title and, in response to determining that the number of historical postings for the posted title is less than a predetermined threshold, supplement the employment responsibilities with information included in an industry classification system for the posted title. To construct the responsibilities database, the one or more processors also are configured to rank the employments responsibilities of the posted title for relevancy to enable identification of a predetermined number of the highest ranked employments responsibilities as the suggested responsibilities for the posted title.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example environment in which an employment website entity creates a resume for a candidate and a job posting for a recruiter via employment apps in accordance with the teachings herein.

FIG. 2 is a block diagram of electronic components of the employment website entity of FIG. 1.

FIG. 3 illustrates an example interface of an example employment app for creating a resume in accordance with the teachings herein.

FIG. 4 illustrates another example interface of the employment app of FIG. 3 in a first state.

FIG. 5 illustrates another example interface of the employment app of FIG. 3 in a first state.

FIG. 6 illustrates another example interface of the employment app of FIG. 3.

FIG. 7 illustrates the interface of FIG. 5 in a second state.

FIG. 8 illustrates another example interface of the employment app of FIG. 3.

FIG. 9 illustrates the interface of FIG. 4 in a second state.

FIG. 10A illustrates another example interface of the employment app of FIG. 3.

FIG. 10B illustrates another example interface of the employment app of FIG. 3.

FIG. 11 illustrates another example interface of the employment app of FIG. 3.

FIG. 12 is a flowchart of an example automated method to create a resume for a candidate based on limited candidate-generated information in accordance with the teachings herein.

FIG. 13 is a flowchart of an example method to generate a database with position titles of employers in accordance with the teachings herein.

FIG. 14 is a flowchart of an example method to generate a database with suggested responsibilities for position titles of employers in accordance with the teachings herein.

FIG. 15 illustrates an example interface of an example employment app for creating a job posting in accordance with the teachings herein.

FIGS. 16A-16B illustrate another example interface of the employment app of FIG. 15 in a first state.

FIG. 17 illustrates a portion of another example interface of the employment app of FIG. 15.

FIG. 18 illustrates another example interface of the employment app of FIG. 15.

FIGS. 19A-19B illustrate the interface of FIGS. 16A-16B in a second state.

FIG. 20 is a flowchart of an example automated method to create a job posting for an employment position based on limited recruiter-generated information in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Example methods and apparatus disclosed herein include an employment app for collecting a limited amount of user-generated work-experience information (e.g., employer name, position title, location, period of employment) from a job seeker, automatically identifying suggested employment responsibilities for the job seeker based on the limited amount of user-generated information, receiving a selection of some of the suggested employment responsibilities that reflect the job seeker's work experience, and automatically generating a resume for the job seeker utilizing the selected employment responsibilities and the limited user-generated information. Thus, the examples disclosed herein include a specific set of rules that provide an unconventional technological solution of automatically generating a resume, that is representative of a job seeker's experience and attractive to potential employers, based on limited user-generated information to a technological problem of providing assistance to job seekers in creating a resume.

Further, example methods and apparatus disclosed herein include an employment app for collecting a limited amount of user-generated position information (e.g., job title, location, company name) from a recruiter, automatically identifying suggested employment responsibilities for an open employment position associated with the recruiter based on the limited amount of user-generated information, receiving a selection of some of the suggested employment responsibilities for the open employment position, and automatically generating a posting for the position associated with the recruiter utilizing the selected employment responsibilities and the limited user-generated information. Thus, the examples disclosed herein include a specific set of rules that provide an unconventional technological solution of automatically generating a job posting, that is representative of a position's responsibilities and attractive to potential candidates, based on limited user-generated information to a technological problem of providing assistance to recruiters in creating a job posting.

Examples disclosed herein also include improved user interfaces for computing devices that are particularly structured to collect and present resume-related and job-posting-related information in an easy-to-follow, time-efficient manner for a job seeker and a candidate, respectively. More specifically, example interfaces disclosed herein are specifically configured to facilitate the presentation and/or collection of resume-related and job-posting-related information on small screens of mobile devices (e.g., smart phones, tablets, etc.), which are being used more-and-more over time as a primary computing device. For instance, if a job seeker attempted to create a resume using a word processor on a mobile device, that job seeker would have to scroll and switch views many times to find and modify targeted portions of the resume. Similarly, if a recruiter attempted to create a job posting using a word processor on a mobile device, that recruiter would have to scroll and switch views many times to find and modify targeted portions of the job posting. Thus, examples disclosed herein improve the efficiency of using a computing device to create a resume and/or a job posting by including interfaces that are specifically configured to present and/or collect particular sets of information to facilitate the automated generation of a resume for the job-seeker and/or a job posting for the recruiter.

Examples disclosed herein include an employment app of an employment website entity that is utilized for the automated creation (e.g., in real-time) of a resume for a candidate and/or a job posting for a recruiter based on limited user-generated information provided by the candidate and/or the recruiter, respectively.

As used herein, an “employment website entity” refers to an entity that operates and/or owns an employment website and/or an employment app. As used herein, an “employment website” refers to a website and/or any other online service that facilitates job placement, career, and/or hiring searches. Example employment websites include CareerBuilder.com®, Sologig.com®, etc. As used herein, an “employment app” and an “employment application” refer to a process of an employment website entity that is executed on a mobile device, a desktop computer, and/or within an Internet browser of a candidate. For example, an employment application includes a mobile app that is configured to operate on a mobile device (e.g., a smart phone, a smart watch, a wearable, a tablet, etc.), a desktop application that is configured to operate on a desktop computer, and/or a web application that is configured to operate within an Internet browser (e.g., a mobile-friendly website configured to be presented via a touchscreen of a mobile device).

As used herein, a “candidate” and a “job seeker” refer to a person who is searching for a job, position, and/or career. As used herein, “candidate information” refers to contact information and/or qualification information of a candidate provided in a resume of the candidate. For example, candidate information includes contact information (e.g., a phone number, an email address, a street address), educational information (e.g., degrees, GPA, etc.), work experience, skills information, licensing information (e.g., occupational licenses), employment information, etc. As used herein, “employment information” and “work experience information” refer to information that describes previous employment positions held by a candidate. For example, employment information includes an employer name, a position title, a job location, a period of employment, and responsibilities performed for the position.

As used herein, a “recruiter” refers to a person and/or entity (e.g., a company, a corporation, etc.) that solicits one or more candidates to apply for a position and/or a job. For example, a recruiter may include an employer, an employee and/or other representative (e.g., a human resources representative, etc.) of an employer, and/or third-party headhunter.

As used herein, “user-generated information” refers to information, such as candidate-generated information and/or recruiter-generated information, collected from a user that was not suggested to the user via an employment website and/or an employment app. As used herein, “candidate-generated information” refers to information collected from a candidate that was not suggested to the candidate via an employment website and/or an employment app. As used herein, “recruiter-generated information” refers to information collected from a recruiter that was not suggested to the recruiter via an employment website and/or an employment app.

As used herein, “computer-suggested information” refers to information that a computing device identifies and suggests as potential information to a user, such as potential candidate information to a candidate and/or potential posting information to a recruiter. For example, a computing device may select the computer-suggested information based on previously collected user-generated information. For instance, upon being presented with the computer-suggested information, a candidate may select one or more items of the computer-suggested information as candidate information for the candidate. Similarly, upon being presented with the computer-suggested information, a recruiter may select one or more items of the computer-suggested information as posting information for the recruiter.

As used herein, “real-time” refers to a time period that is simultaneous to and/or immediately after user (e.g., a candidate, a recruiter) enters a keyword into an employment website. For example, real-time includes a time duration before a session of the user with an employment app ends. As used herein, a “session” refers to an interaction between a user (e.g., a candidate, a recruiter) and an employment app. Typically, a session will be relatively continuous from a start point to an end point. For example, a session may begin when the user opens and/or logs onto the employment website and may end when the user closes and/or logs off of the employment website.

During a session of a candidate on an employment app, an app manager of examples disclosed herein obtains employment information of the candidate via the employment app for positions previously held by the candidate. For example, for each of the previously held positions, the employment app presents a position interface that prompts the candidate to provide employment information related to the previously held position. Subsequently, the app manager collects, via the employment app, the employment information from the candidate for the previously held position. For example, the app manager collects an employer name, a position title, a location of employment, and/or a period of employment. In some examples, the employer name, the position title, the location of employment, and the period of employment are use-generated by the candidate. In other examples, the position title is computer-suggested information that the candidate selects upon the app manager suggesting one or more computer-suggested position titles to the candidate via a title interface of the employment app. For example, the computer-suggested position titles are retrieved from a database (e.g., an employer-title database) based on, at least in part, the user-generated employer name. In some such examples, the computer-suggested position titles were identified based upon analysis of historical (e.g., past and current) employment postings.

Further, for each of the previously held positions, the app manager presents a responsibilities interface of the employment app that includes a list of one or more computer-suggested responsibilities. For example, the computer-suggested responsibilities are retrieved from a database (e.g., a responsibilities database) based on, at least in part, the employer name, the position title, the location of employment, and/or the period of employment from the candidate that was collected from the candidate. In some such examples, the computer-suggested responsibilities were identified based upon analysis of historical (e.g., past and current) employment postings.

Subsequently, a resume/posting generator creates a resume for the candidate based upon the employment information (e.g., the employer name, the position title, the location of employment, the period of employment, and the responsibilities for the previously held positions) and other information (e.g., contact information, education information, etc.) collected from the candidate. For example, the resume/posting generator formats the resume into a pdf document and/or a word processing document in a standard paper size such that the resume is attractive to and easily processed by potential employers. After the candidate reviews and approves of the resume created by the resume/posting generator, the resume is stored in a database and/or submitted to potential employers on behalf of the candidate.

Similarly, during a session of a recruiter on an employment app, the app manager of examples disclosed herein obtains posting information from the recruiter via the employment app for an employment position corresponding with the recruiter. For example, the employment app presents one or more interfaces that prompt the recruiter to provide a position title, a location, and/or an employer name of the position. Further, the app manager presents a responsibilities interface of the employment app that includes a list of one or more computer-suggested responsibilities for the employment position. For example, the computer-suggested responsibilities are retrieved from a database (e.g., the responsibilities database) based on, at least in part, the position title, the location of employment, and/or the employer name that was previously collected from the recruiter. In some such examples, the computer-suggested responsibilities were identified based upon analysis of historical (e.g., past and current) employment postings.

Subsequently, the resume/posting generator creates a posting for the recruiter based upon the recruiter-generated information (e.g., the position title, the employer name, the location of employment) and recruiter-selected computer-suggested information (e.g., job responsibilities, preferred skills, preferred experience, preferred education, etc.) collected from the recruiter. The resume/posting generator formats the job posting in a manner that is attractive to and easily processed by potential employers on an employment app. After the recruiter reviews and approves of the job posting created by the resume/posting generator, the job posting is stored in a database and/or posted on an employment app for candidates.

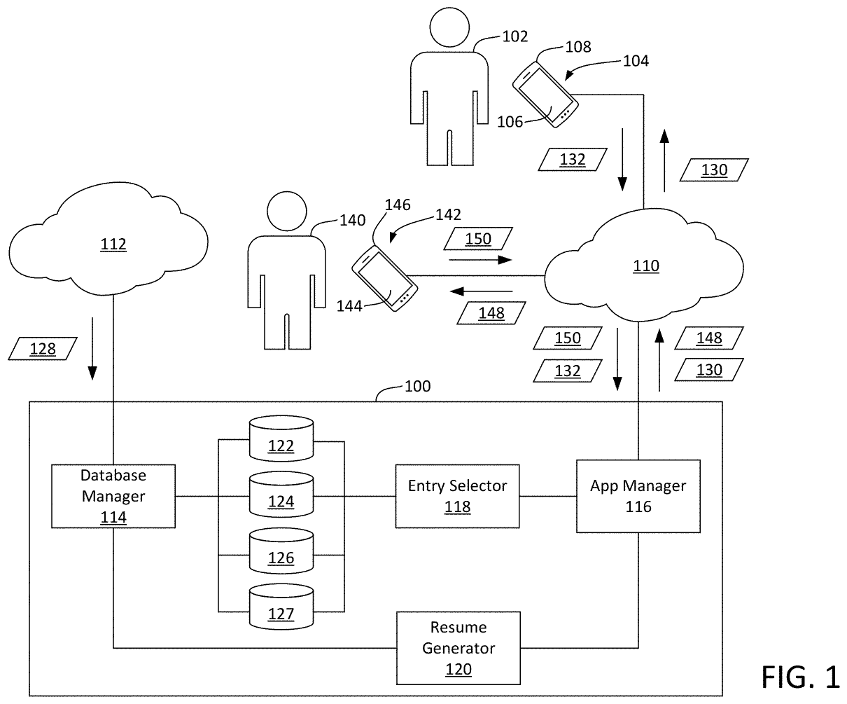

Turning to the figures, FIG. 1 illustrates an example employment website entity 100 (e.g., CareerBuilder.com®) that presents employment opportunities and submits applications for a candidate 102 via an employment app 104 in accordance with the teachings herein. In the illustrated example, a touchscreen 106 of a mobile device 108 (e.g., a smartphone, a tablet, etc.) presents the employment app 104. For example, the touchscreen 106 is (1) an output device that presents interfaces of the employment app 104 to the candidate 102 and (2) an input device that enables the candidate 102 to input information by touching the touchscreen 106. Additionally or alternatively, the employment app 104 is configured to be presented via a touchscreen of a stationary computing device and/or a non-touch display of a computing device (e.g., a desktop, a laptop, a mobile device, etc.). Further, in some examples, the computing device is configured to receive information from the candidate 102 via other input device(s) (e.g., a button, a keyboard, a mouse, voice command, etc.). In the illustrated example, the candidate 102 interacts with the employment app 104 during a session of the candidate 102 on the employment app 104.

As illustrated in FIG. 1, the mobile device 108 of the candidate 102 and employment website entity 100 are in communication with each other via a network 110 (e.g., via a wired and/or a wireless connection). The network 110 may be a public network, such as the Internet; a private network, such as an intranet; or combinations thereof. The employment website entity 100 of the illustrated example also is in communication with another network 112 (e.g., via a wired and/or a wireless connection). The network 112 may be a public network, such as the Internet; a private network, such as an intranet; or combinations thereof. In the illustrated example, the network 112 is separate from the network 110. In other examples, the network 110 and the network 112 are integrally formed.

The employment website entity 100 of the illustrated example also is configured to present job postings and collects corresponding applications for a recruiter 140 via an employment app 142 in accordance with the teachings herein. In the illustrated example, a touchscreen 144 of a mobile device 146 (e.g., a smartphone, a tablet, etc.) presents the employment app 142. For example, the touchscreen 144 is (1) an output device that presents interfaces of the employment app 142 to the recruiter 140 and (2) an input device that enables the recruiter 140 to input information by touching the touchscreen 144. Additionally or alternatively, the employment app 142 is configured to be presented via a touchscreen of a stationary computing device and/or a non-touch display of a computing device (e.g., a desktop, a laptop, a mobile device, etc.). Further, in some examples, the computing device is configured to receive information from the recruiter 140 via other input device(s) (e.g., a button, a keyboard, a mouse, voice command, etc.). In the illustrated example, the recruiter 140 interacts with the employment app 142 during a session of the recruiter 140 on the employment app 142. As illustrated in FIG. 1, the mobile device 146 of the recruiter 140 and employment website entity 100 are in communication with each other via the network 110. In other examples, the mobile device 146 is in communication with the employment website entity 100 via the network 112 and/or another network.

The employment website entity 100 of the illustrated example includes a database manager 114, an app manager 116, an entry selector 118, a resume/posting generator 120, an employer-title database 122, a responsibilities database 124, a resume database 126, and a posting database 127. The database manager 114 adds, removes, modifies, and/or otherwise organizes data within the employer-title database 122, the responsibilities database 124, the resume database 126, and the posting database 127. The app manager 116 controls operation of the employment app 104 by collecting information from, processing information, and providing information to the candidate 102 via the mobile device 108. The app manager 116 also controls operation of the employment app 142 by collecting information from, processing information, and providing information to the recruiter 140 via the mobile device 146. The entry selector 118 selects information to retrieve and retrieves the information from the employer-title database 122, responsibilities database 124, the resume database 126, and/or the posting database 127. The resume/posting generator 120 is configured to create a resume (e.g., a resume 1102 of FIG. 11) for the candidate 102 based on information collected by the app manager 116 from the candidate 102 via the employment app 104. The resume/posting generator 120 also is configured to create a job posting for the recruiter 140 based on information collected by the app manager 116 from the recruiter 140 via the employment app 142. Further, the employer-title database 122 (i) stores employer names and employment titles that correspond with the employer names and/or links one or more employment titles that correspond with a particular employer name. The responsibilities database 124 stores responsibilities for employment titles of employers. For example, the responsibilities database 124 links one or more responsibilities that correspond with a particular employment title of a particular employer name. The resume database 126 stores resumes created by the resume/posting generator 120. For example, the resume database 126 links a resume of the candidate 102 to a user ID of the candidate 102. Additionally, the posting database 127 stores postings and/or job descriptions created by the resume/posting generator 120. For example, the posting database 127 links a posting and/or job description of the recruiter 140 to a user ID of the recruiter 140.

In operation, the database manager 114 constructs the employer-title database 122 and organizes links between the responsibilities and the employment titles of the employers within the employer-title database 122. For example, the database manager 114 collects historical data 128 that includes historical employment postings from the network 112. The database manager 114 collects employment postings previously posted via the employment app 142, another employment app and/or website of the employment website entity 100, and/or other website(s) with employment postings. In some examples, the database manager 114 performs web scraping to extract information for the historical employment postings one or more internal networks (e.g., a network of the employment website entity 100) and/or external networks (e.g., the Internet). Further, in some examples, the database manager 114 utilizes text mining software to identify pieces of information, such as the employer and the employment title, within the collected historical postings. Upon collecting the historical postings, the database manager 114 normalizes and/or cleans the collected postings to remove unrelated noise from the collected postings.

For each of the employers identified within the collected postings, the database manager 114 clusters together employment titles of the employer within the collected postings (e.g., utilizing hierarchical clustering, k-means clustering, nearest neighbor classifications, etc.). For example, the database manager 114 clusters together sets of the employment titles included within the collected postings of the employer based on the degree of similarity between the employment titles. For each of the identified clusters, the database manager 114 selects one of the employment titles within the cluster as a representative title. In some examples, the database manager 114 modernizes the representative title to facilitate the resume/posting generator 120 in creating (i) a resume that is attractive to current employers for current employment positions and/or or (ii) a posting that is attractive to potential candidates. After the employment title is determined, the database manager 114 saves the employment title within the employer-title database 122 such that the employment title is linked to the corresponding employer name.

Further, in operation, the database manager 114 constructs the responsibilities database 124 and organizes links between the responsibilities and the employment titles of the employers within the responsibilities database 124. For example, the database manager 114 collects the historical employment postings from the network 112. The database manager 114 identifies pieces of information, such as the employer name, the employment title, and job responsibilities, within the collected historical postings.

For each employer title of each employer identified within the collected postings, the database manager 114 identifies each of the responsibilities within descriptions of the historical postings for the particular employment title for the particular employer. For example, the database manager 114 utilizes parts-of-speech (POS) tags, dependency parse trees, and/or other text recognition algorithms to identify the responsibilities within the descriptions of the postings. If the number of identified posting descriptions of a particular employment title for a particular employer is less than a predetermined threshold, the database manager 114 supplements the responsibilities identified with the historical postings with information included in an industry classification system (e.g., the North American Industry Classification System (NAICS)) for the particular employment title. For example, the predetermined threshold corresponds with a number of posting descriptions that enables the database manager 114 to consistently identify an accurate list of responsibilities associated with the particular employment title of the particular employer. Otherwise, if the number of identified posting descriptions of the particular employment title for the particular employer is greater than or equal to the predetermined threshold, the database manager 114 may not supplement the responsibilities identified with the historical postings with information included in the industry classification system.

After the responsibilities of the employment title of the employer are determined, the database manager 114 ranks the responsibilities based on relevancy to the particular employment title of the employer and saves the ranked responsibilities within the employer-title database 122 such that the responsibilities are linked to the corresponding employment title of the employer. For example, database manager 114 ranks the responsibilities to enable subsequent identification of a predetermined number of the highest ranked employments responsibilities for the particular employment title of the employer.

In some examples, the database manager 114 refines the identified responsibilities based upon the geographic regions that correspond to a particular employment title of a particular employer to account for differences of responsibilities of the same position within different geographic regions. For example, the database manager 114 localizes the responsibilities based on identified responsibilities of historical postings for different geographic locations such that a first set of responsibilities correspond with the particular employment title of the particular employer in a first geographic region and a second set of responsibilities correspond with the particular employment title of the particular employer in a second geographic region. By localizing the employment responsibilities within the responsibilities database 124, the database manager 114 facilitates the resume/posting generator 120 to create (i) a resume that is tailored to a preferred employment location of the candidate 102 and/or (ii) a posting that is tailored to the location of the position associated with the recruiter 140. Further, in some examples, the database manager 114 modernizes the identified responsibilities to account for re-characterizations of responsibilities over time. For example, the database manager 114 updates how the identified responsibilities are described to facilitate the resume/posting generator 120 in creating (i) a resume that is attractive to current employers for current employment positions and/or (ii) a job posting that is attractive to current candidates.

Once the employer-title database 122 and the responsibilities database 124 are constructed, the app manager 116 operates the employment app 104 to collect information that enables the resume/posting generator 120 to create (i) a resume for the candidate 102 during a session of the candidate 102 on the employment app 104 and/or (ii) a job posting for the recruiter 140 during a session of the recruiter 140 on the employment app 142.

To enable the creation of a resume for the candidate 102, the app manager 116, as illustrated in FIG. 1, is in communication with the mobile device 108 of the candidate 102, via the network 110, to collect information from the candidate 102. In the illustrated example, the app manager 116 sends app data 130 (e.g., interfaces of the employment app 104, suggested employment titles, suggested responsibilities, etc.) that are presented to the candidate 102 via the touchscreen 106 of the mobile device 108. Further, the app manager 116 collects candidate data 132 (e.g., contact information, work experience information, education information, etc.) that the candidate 102 provides via the employment app 104.

For example, the app manager 116 collects, via the employment app 104, work experience for previous positions held by the candidate 102. To obtain the work experience for each of the previously held positions, the app manager 116 presents a position interface of the employment app 104 to the candidate 102. Subsequently, the app manager 116 collects, via the position interface, an employer name for the previous position that is user-generated by the candidate 102. In some examples, the app manager 116 collects, via the position interface, an employment title for the previous position that is user-generated by the candidate 102. In other examples, the employment title is computer-suggested. For example, upon the app manager 116 collecting the employer name from the candidate 102, the entry selector 118 retrieves, in real-time, computer-suggested employment titles from the employer-title database 122 based on the user-generated employer name. In such examples, the app manager 116 presents the suggested employment titles to the candidate 102, via a title interface of the employment app 104, to enable the candidate 102 to select one of suggested employment titles as the employment title that corresponds to the previous position held by the candidate. Further, the app manager 116 collects, via the position interface, a location and a period of employment for the previous position held by the candidate 102.

In response to the app manager 116 collecting the employer name, the employment title, the location, and the period of employment for the previously held position, the entry selector 118 retrieves computer-suggested employment responsibilities from the responsibilities database 124 for the previously held position. For example, the entry selector 118 retrieves, in real-time, the suggested employment responsibilities based on the limited amount of previously-collected work experience information (e.g., the employer name, the employment title, the location, the period of employment). Subsequently, the app manager 116 presents the suggested responsibilities to the candidate within a responsibilities interface of the employment app 104. The candidate 102 selects one or more of the suggested responsibilities via the responsibility interface of the employment app 104. For example, by selecting a suggested responsibility, the candidate 102 indicates that the candidate 102 performed the selected responsibility for the previous position. Further, the app manager 116 collects the one or more responsibilities that the candidate 102 selected via the employment app 104.

After the app manager 116 collects the selected computer-suggested employment information and the limited amount of user-generated employment information for one or more previous positions of the candidate 102, the resume/posting generator 120 creates a resume for the candidate 102 based upon the collected information. That is, the resume/posting generator 120 creates a resume for the candidate 102 (e.g., in real-time) utilizing the computer-suggested, user-selected employment responsibilities to reduce an amount of user-generated information needed to create an accurate and complete resume for the candidate 102. For example, the resume/posting generator 120 creates the resume as a pdf document and/or a word processing document in a standard paper size that is attractive to and easily processed by potential employers. Further, the database manager 114 stores the resume created by the resume/posting generator 120 in the resume database 126 and links the resume to a user ID of the candidate 102 within the resume database 126. Additionally or alternatively, the app manager 116 submits the resume of the candidate 102 to an employer for a potential employment opportunity.

Similarly, to enable the creation of a job posting for the recruiter 140, the app manager 116, as illustrated in FIG. 1, is in communication with the mobile device 146 of the recruiter 140, via the network 110, to collect information from the recruiter 140. In the illustrated example, the app manager 116 sends app data 148 (e.g., interfaces of the employment app 142, suggested responsibilities, etc.) that are presented to the recruiter 140 via the touchscreen 144 of the mobile device 146. Further, the app manager 116 collects posting data 150 (e.g., a job title, a job location, an employer, etc.) that the recruiter 140 provides via the employment app 142.

For example, the app manager 116 collects a job title for a job posting from the recruiter 140 via the employment app 142. To obtain the job title, the app manager 116 presents a title interface of the employment app 142 to the recruiter 140. Subsequently, the app manager 116 collects, via the title interface, the job title for the job posting from the recruiter 140. Further, in some examples, the app manager 116 collects a job location and an employer name for the job posting from the recruiter 140. For example, to obtain the employer name and the job location, the app manager 116 presents an employer interface and a location interface, respectively, of the employment app 142 to the recruiter 140. Subsequently, the app manager 116 collects, via the employer interface and the location interface, the employer name and the job location for the job posting from the recruiter 140. In other examples, the app manager 116 is configured to collect the employer name and/or the job location for the job posting via the title interface and/or other interface(s) of the employment app 142.

In response to the app manager 116 collecting the job title, the location, and/or the employer name, the entry selector 118 retrieves computer-suggested employment responsibilities from the responsibilities database 124 for the employment position associated with the recruiter 140. That is, the entry selector 118 retrieves, in real-time, the suggested employment responsibilities based on the limited amount of previously-collected information (e.g., the job title, the location, the employer name). Subsequently, the app manager 116 presents the suggested responsibilities to the candidate within a responsibilities interface of the employment app 142. The recruiter 140, via the responsibility interface, selects one or more of the suggested responsibilities that correspond with the responsibilities of the employment position. For example, by selecting a suggested responsibility, the recruiter 140 indicates that a candidate would perform the selected responsibility if hired for the employment position corresponding with the job posting. Further, the app manager 116 collects the one or more responsibilities that the recruiter 140 selected via the employment app 142.

After the app manager 116 collects the user-selected computer-suggested information and the limited amount of user-generated information for the employment position, the resume/posting generator 120 creates a job posting for the employment position based upon the collected information. That is, the resume/posting generator 120 creates a description of the employment position for the job posting of the recruiter 140 (e.g., in real-time) utilizing the computer-suggested, user-selected responsibilities to reduce an amount of user-generated information needed to create an accurate and complete job description for a posting. Further, the database manager 114 stores the job description and/or the job posting created by the resume/posting generator 120 in the posting database 127 and links the description and/or posting to a user ID of the recruiter 140 within the posting database 127. Additionally or alternatively, the app manager 116 presents the job posting to one or more candidates (e.g., the candidate 102) via the employment app 104 for candidates.

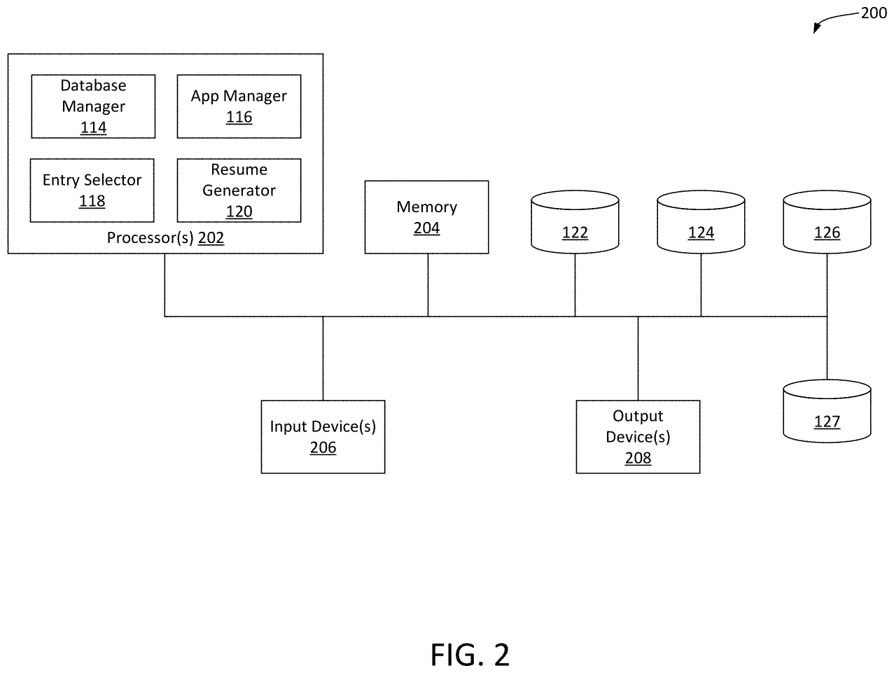

FIG. 2 is a block diagram of electronic components 200 of the employment website entity 100. As illustrated in FIG. 2, the electronic components 200 include one or more processors 202 (also referred to as microcontroller unit(s) and controller(s)). Further, the electronic components 200 include memory 204, the employer-title database 122, the responsibilities database 124, the resume database 126, the posting database 127, input device(s) 206, and output device(s) 208. In the illustrated example, each of the employer-title database 122, the responsibilities database 124, the resume database 126, and the posting database 127 is a separate database. In other examples, two or more of the employer-title database 122, the responsibilities database 124, the resume database 126, and the posting database 127 are integrally formed as a single database.

In the illustrated example, the processor(s) 202 are structured to include the database manager 114, the app manager 116, the entry selector 118, and the resume/posting generator 120. The processor(s) 202 of the illustrated example include any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). Further, the memory 204 is, for example, volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 204 includes multiple kinds of memory, such as volatile memory and non-volatile memory.

The memory 204 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 204, the computer readable medium, and/or within the processor(s) 202 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

In the illustrated example, the input device(s) 206 enable a user, such as an information technician of the employment website entity 100, to provide instructions, commands, and/or data to the processor(s) 202. Examples of the input device(s) 206 include one or more of a button, a control knob, an instrument panel, a touch screen, a touchpad, a keyboard, a mouse, a speech recognition system, etc.

The output device(s) 208 of the illustrated example display output information and/or data of the processor(s) 202 to a user, such as an information technician of the employment website entity 100. Examples of the output device(s) 208 include a liquid crystal display (LCD), an organic light emitting diode (OLED) display, a flat panel display, a solid state display, and/or any other device that visually presents information to a user. Additionally or alternatively, the output device(s) 208 may include one or more speakers and/or any other device(s) that provide audio signals for a user. Further, the output device(s) 208 may provide other types of output information, such as haptic signals.

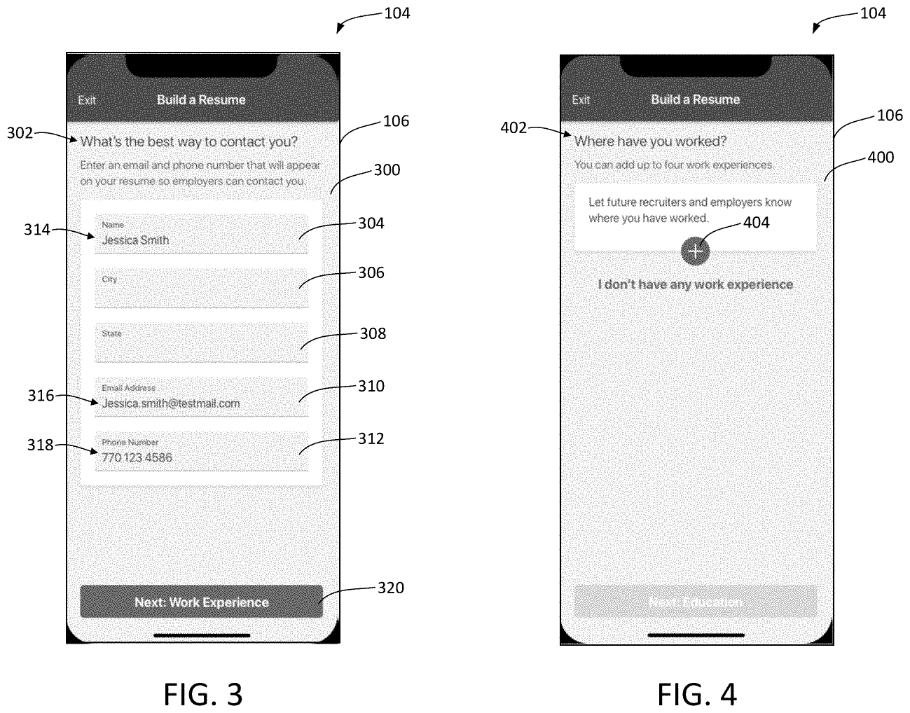

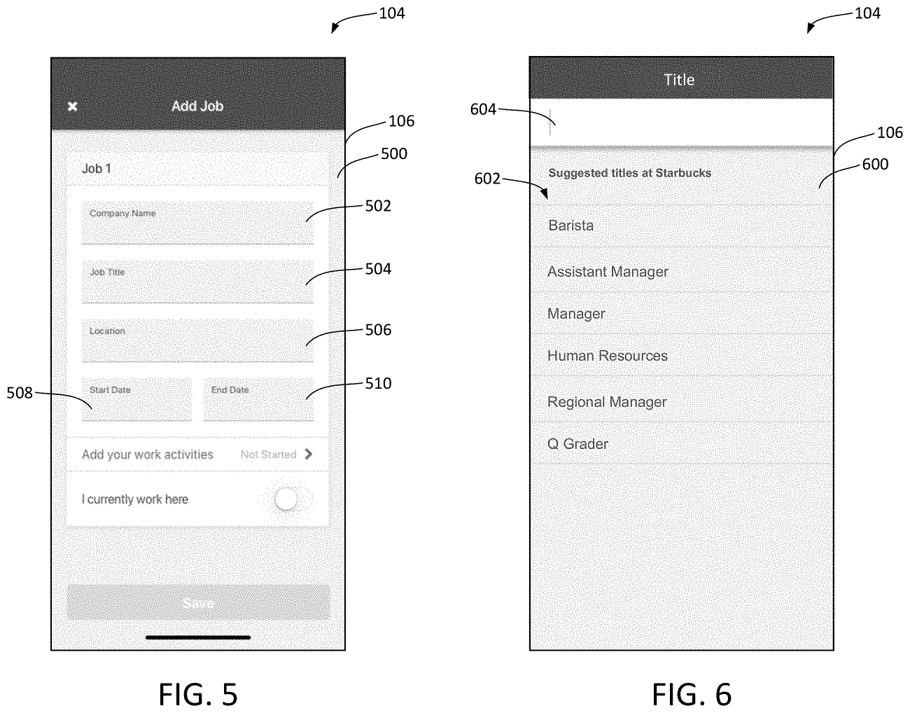

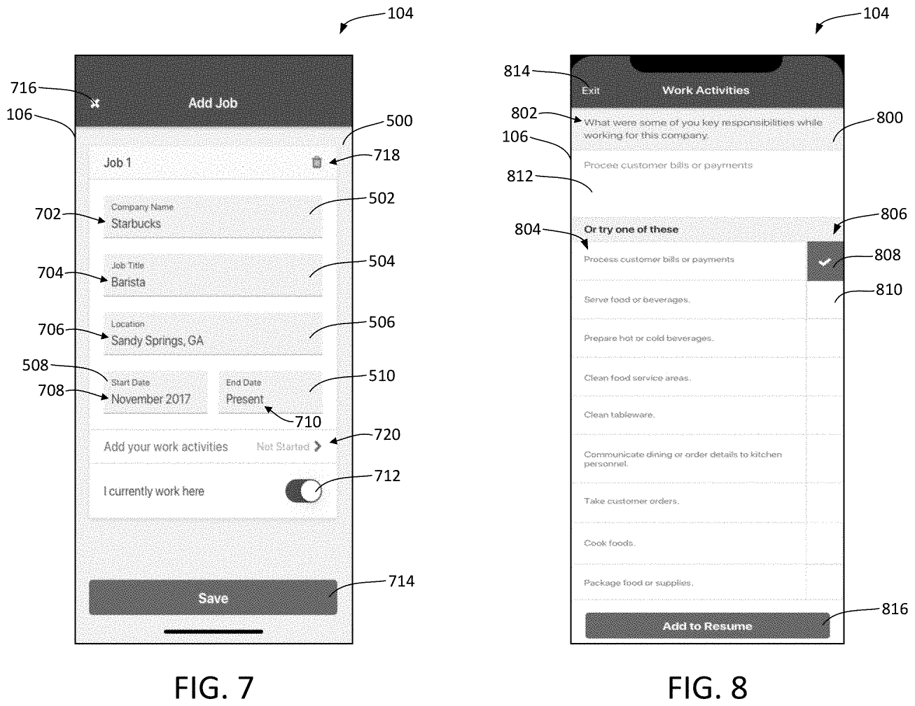

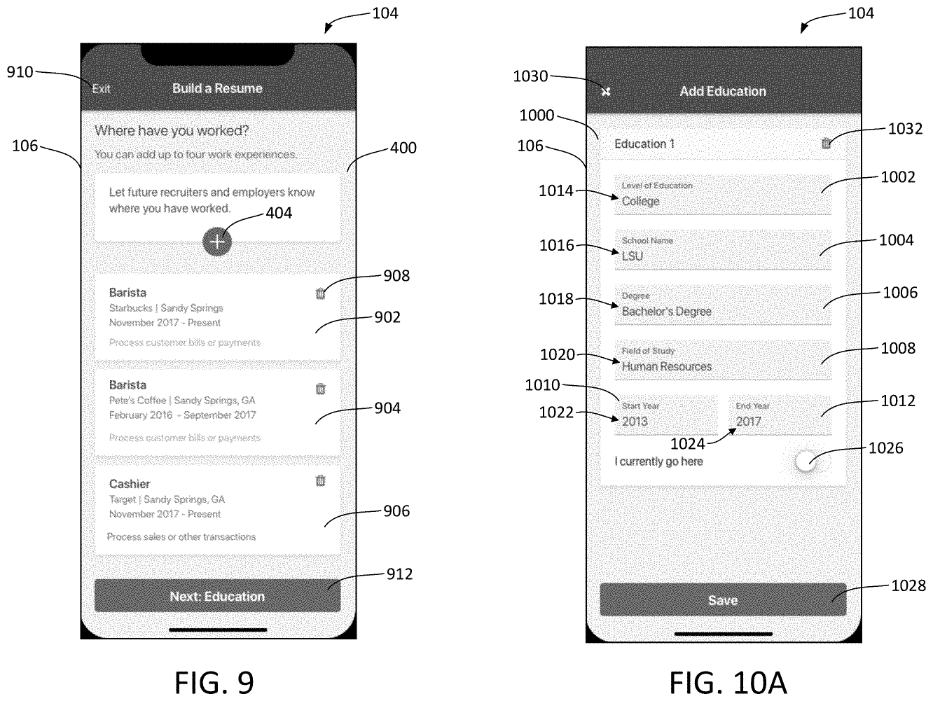

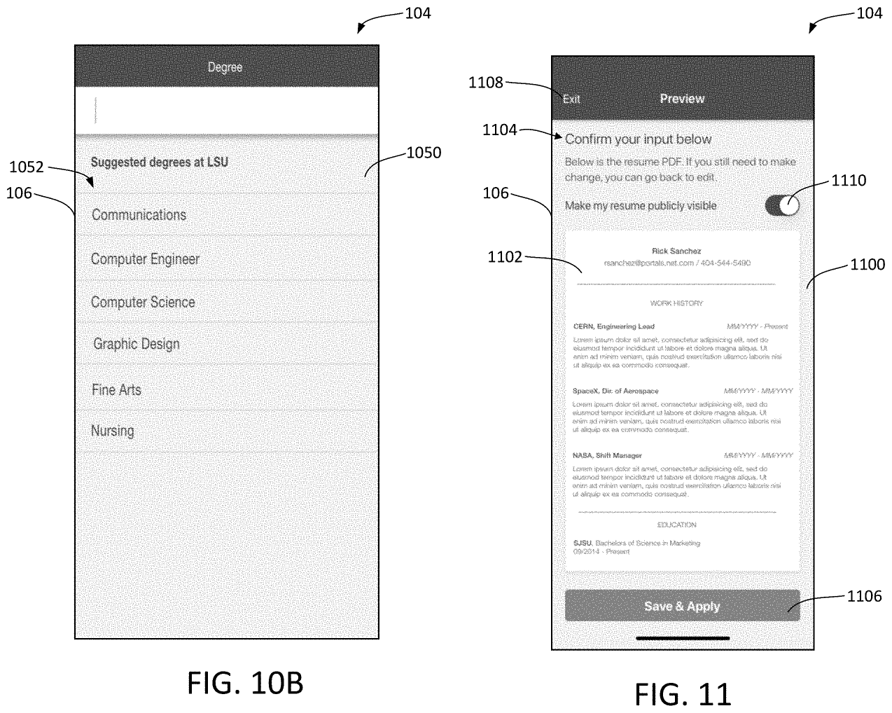

FIGS. 3-11 depict example interfaces of the employment app 104. The example interfaces are configured to be presented via the touchscreen 106 of the mobile device 108 and/or other display(s) of other computing device(s). The interfaces are particularly structured, individually and in conjunction with each other, to collect and present resume-related information in an easy-to-follow manner that enables the candidate 102 to conveniently utilize the mobile device 108 and/or another computing device for quickly creating an attractive resume for the candidate 102. That is, the employment app 104 includes a plurality of interfaces configured to facilitate the app manager 116 in quickly collecting information from the candidate 102. In particular, FIG. 3 depicts an example contact information interface 300, FIG. 4 depicts an example work experience interface 400 in a first state, FIG. 5 depicts an example position interface 500 in a first state, FIG. 6 depicts an example title interface 600, FIG. 7 depicts the example position interface 500 in a second state, FIG. 8 depicts an example responsibilities interface 800, FIG. 9 depicts the work experience interface 400 in a second state, FIG. 10A depicts an example education interface 1000, FIG. 10B depicts an example field-of-study interface 1050, and FIG. 11 depicts an example resume interface 1100.

As illustrated in FIG. 3, the employment app 104 includes the contact information interface 300 that is initially presented to the candidate 102 to enable the app manager 116 to receive contact information of the candidate 102. The contact information includes a prompt 302 informing the candidate 102 to provide their contact information. In the illustrated example, the prompt 302 informs the candidate 102 that at least some of the collected contact information (e.g., name, phone number, email address) will be included in the resume (e.g., a resume 1102 of FIG. 11) generated for the candidate 102.

As illustrated in FIG. 3, the contact information interface 300 includes a series of textboxes that enable the candidate 102 to quickly provide their contact information. For example, the contact information interface 300 includes a name textbox 304, a city textbox 306, a state textbox 308, an email address textbox 310, and a phone number textbox 312. As illustrated in FIG. 3, the name textbox 304 enables the candidate 102 to enter a name 314 of the candidate 102, the email address textbox 310 enables the candidate 102 to enter an email address 316 of the candidate 102, and the phone number textbox 312 enables the candidate 102 to enter a phone number 318 of the candidate 102. Further, the city textbox 306 enables the candidate 102 to enter a city, town, village, and/or other municipality in which the candidate 102 lives and/or is otherwise looking for employment, and the state textbox 308 enables the candidate 102 to enter a state, providence, and/or other region in which the candidate 102 lives and/or is otherwise looking for employment. In the illustrated example, the app manager 116 is configured to receive the contact information textually (e.g., via a cursor, physical buttons of a keyboard, digital buttons of a touchscreen, etc.) and/or audibly (e.g., via a microphone and speech-recognition software) from the candidate 102 via the employment app 104. Further, as illustrated in FIG. 3, the contact information interface 300 also includes a submission button 320. In response to the candidate 102 selecting the submission button 320 (e.g., identified with text such as “Next: Work Experience”), the app manager 116 saves the collected contact information and the employment app 104 presents the work experience interface 400 to the candidate 102.

As illustrated in FIG. 4, the work experience interface 400 (also referred to as an employment interface) of the employment app 104 includes a prompt 402 that instructs the candidate 102 to add work experience (e.g., to let future recruiters and employers know where you have worked). In the illustrated example, the prompt 402 informs the candidate 102 that the employment app 104 limits the number of work experiences the candidate 102 is able to add. For example, the employment app 104 limits the candidate 102 to adding less than or equal to a predetermined number of previous positions of employment to facilitate the resume/posting generator 120 in effectively highlighting the most relevant work experience of the candidate 102 when creating the resume. In other examples, the employment app 104 does not limit the number of previous positions of employment added by the candidate 102. Further, the work experience interface 400 of the illustrated example includes an add button 404 that enables the candidate 102 to add work experience information via the employment app 104. For example, in response to the candidate 102 selecting the add button 404, the employment app 104 presents the position interface 500 to the candidate 102. In the illustrated example, the app manager 116 is configured to receive a selection of the add button 404 tactilely (e.g., via a cursor, physical buttons of a keyboard, digital buttons of a touchscreen, etc.) and/or audibly (e.g., via a microphone and speech-recognition software) from the candidate 102 via the employment app 104.

As illustrated in FIG. 5, the position interface 500 of the employment app 104 enables the app manager 116 to collect work experience information (e.g., an employer name, an employment title, a location, a period of employment) for a previous position of employment of the candidate 102. In the illustrated example, the position interface 500 includes a series of textboxes that enable the candidate 102 to quickly provide a work experience information for a particular previous position of employment of the candidate 102. For example, the position interface 500 includes an employer name textbox 502 (also referred to as a company name textbox), an employment title textbox 504 (also referred to as a job title textbox), a location textbox 506, a start date textbox 508, and an end date textbox 510. The employer name textbox 502 enables the candidate 102 to enter an employer name for the previous position of the candidate 102, the employment title textbox 504 enables the candidate 102 to enter an employment title for the previous position of the candidate 102, and the location textbox 506 enables the candidate 102 to enter a geographic location of the previous position of the candidate 102. Further, the start date textbox 508 and the end date textbox 510 enable the candidate 102 to enter a period of employment for the candidate 102 at the previous position. For example, the start date textbox 508 enables the candidate 102 to enter a start date for the previous position, and the end date textbox 510 enables the candidate 102 to enter an end date for the previous position. In some examples, in response to the candidate 102 entering an employer name into the employer name textbox 502, the app manager 116 presents the title interface 600 to facilitate the candidate in identifying an employment title for the previous position of the candidate 102 with the employer.

The title interface 600 of the illustrated example facilitates the candidate 102 in providing an employment title to the app manager 116 for the previous position of employment previously identified in the position interface 500. As illustrated in FIG. 6, the title interface 600 includes a list of suggested employment titles 602 that each corresponds with an employer name (e.g., an employer name 702 of FIG. 7) provided by the candidate 102 via the position interface 500. The suggested employment titles 602 of the title interface 600 are computer-suggested information that is collected by the entry selector 118 in real-time from the employer-title database 122 based on the employer name provided by the candidate 102. For example, the employment app 104 is configured to present the title interface 600 with the list of the suggested employment titles 602 upon the candidate 102 (1) providing an employment name via the employer name textbox 502 and (2) subsequently selecting the employment title textbox 504 via the position interface 500. In such examples, the suggested employment titles 602 of the title interface 600 were identified by the entry selector 118 and/or the database manager 114 as being the employment titles most likely to correspond with the employer name provided by the candidate 102. In some examples, the suggested employment titles 602 retrieved by the entry selector 118 in real-time includes a predetermined number of employment titles that most likely correspond with the employer name collected via the position interface 500.

Additionally, in some examples, the list of the suggested employment titles 602 are identified based on other information collected via the position interface 500, such as a location of employment and/or a period of employment. For example, the employment app 104 is configured to present the title interface 600 with the list of the suggested employment titles 602 upon the candidate 102 (1) providing (i) an employer name via the employer name textbox 502, (ii) an employment title via the employment title textbox 504, (iii) an employment location via the location textbox 506, and/or (iv) a period of employment via the start date textbox 508 and the end date textbox 510 and (2) subsequently selecting the employment title textbox 504 via the position interface 500. In such examples, the suggested employment titles 602 were identified as being the employment titles most likely to correspond with the employer name, the employment title, the employment location, and/or period of employment. For example, when the employment location is collected before the title interface 600 is presented, the list of the suggested employment titles 602 is localized based on the employment location such that the list of the suggested employment titles 602 corresponds with positions of the identified employer at the identified employment location. Further, in examples in which the period of employment is collected before the title interface 600 is presented, the list of the suggested employment titles 602 are identified based on the period of employment such that the list of the suggested employment titles 602 corresponds with positions of the identified employer during the identified period of employment.

As illustrated in FIG. 6, the title interface 600 also includes a title textbox 604 that is configured to enable the candidate 102 to enter an employment position. For example, the candidate 102 types an employment title into the title textbox 604 if their employment title for the employer name is not included in the list of the suggested employment titles 602. In the illustrated example, the app manager 116 returns the employment app 104 to the position interface 500 upon the candidate 102 selecting one of the suggested employment titles 602 and/or entering an employment title into the title textbox 604. Further, in the illustrated example, the app manager 116 is configured to receive a selection of the suggested employment titles 602 and/or collect an entry for the title textbox 604 tactilely (e.g., via a cursor, physical buttons of a keyboard, digital buttons of a touchscreen, etc.) and/or audibly (e.g., via a microphone and speech-recognition software) from the candidate 102 via the employment app 104.

FIG. 7 depicts the position interface 500 of the employment app 104 after the candidate 102 has provided the work experience information for a particular previous position of employment. For example, the employer name textbox 502 enables the candidate 102 to enter an employer name 702 (also referred to as a company name), and the employment title textbox 504 enables the candidate 102 to enter an employment title 704 (also referred to as a job title). In some examples, the app manager 116 generates the employment title 704 in the employment title textbox 504 based on a computer-suggested employment title selected by the candidate 102 via the title interface 600. Further, the location textbox 506 enables the candidate 102 to enter a location 706 (e.g., a city and a state), and the start date textbox 508 and the end date textbox 510 enable the candidate 102 to enter a period of employment for the previous position of employment. For example, to identify the period of employment, the candidate 102 enters a start date 708 in the start date textbox 508 and an end date 710 in the end date textbox 510. In the illustrated example, the app manager 116 is configured to receive the experience information textually (e.g., via a cursor, physical buttons of a keyboard, digital buttons of a touchscreen, etc.) and/or audibly (e.g., via a microphone and speech-recognition software) from the candidate 102 via the employment app 104.

Further, the position interface 500 of the illustrated example includes a digital toggle 712 that enables the candidate 102 to identify whether the candidate 102 currently holds this particular position. As used herein, a previous position of employment of a candidate includes a current position of employment of the candidate. The digital toggle 712 has an active position (e.g., a rightward position) and an inactive position (e.g., a leftward position). If this particular position of employment is the current position of the candidate 102, the candidate 102 selects the digital toggle 712 to cause the digital toggle 712 to be in the active position. When the digital toggle 712 is in the active position, the app manager 116 identifies the end date 710 as “Present” in the end date textbox 510. In contrast, if this particular position of employment is not the current position of the candidate 102, the candidate 102 selects the digital toggle 712 to cause the digital toggle 712 to be in the inactive position. When the digital toggle 712 is in the inactive position, the app manager 116 enables the candidate 102 to provide the end date 710 into the end date textbox 510. In some examples, the digital toggle 712 is color-coded. For example, a portion of the digital toggle 712 is grey when in the inactive position, and a portion of the digital toggle 712 is blue when in the active position.

In the illustrated example, the position interface 500 also includes a save button 714, a cancel button 716, and a delete button 718. In response to the candidate 102 selecting the save button 714, the app manager 116 saves any new and/or updated employment information that the candidate 102 has provided via the position interface 500. Further, the employment app 104 returns to the work experience interface 400 upon the candidate 102 selecting the save button 714. In the illustrated example, the cancel button 716 is represented by an ‘x’ to facilitate identification by the candidate 102. In response to the candidate 102 selecting the cancel button 716, the employment app 104 returns to the work experience interface 400 without the app manager 116 saving any new and/or updated employment information collected from the candidate 102. For example, the unsaved employment information is not included in the resume generated for the candidate 102. The delete button 718 of the illustrated example is represented by a garbage can to facilitate identification by the candidate 102. In response to the candidate 102 selecting the delete button 718, the app manager 116 deletes any employment information that the candidate 102 has provided via the position interface 500 for the particular previous position of the candidate 102. For example, the deleted employment information is not included in the resume generated for the candidate 102. Further, the employment app 104 returns to the work experience interface 400 upon the candidate 102 selecting the delete button 718.

Further, the position interface 500 includes a responsibilities button 720 (also referred to as a work activities button). In the illustrated example, the responsibilities button 720 includes text (“Add your work activities”) and an arrow (“>”) that are selectable by the candidate 102. In response to the candidate 102 selecting the responsibilities button 720, the employment app 104 enables the candidate 102 to identify responsibilities that the candidate 102 performed for the particular previous position of employment. For example, upon the candidate 102 selecting the responsibilities button 720, the app manager 116 presents the responsibilities interface 800 that enables the candidate 102 to select which responsibilities corresponded with the particular previous position of employment. In the illustrated example, the app manager 116 is configured to receive the employment information and/or a selection of the digital toggle 712, the save button 714, the cancel button 716, and/or the delete button 718 tactilely (e.g., via a cursor, physical buttons of a keyboard, digital buttons of a touchscreen, etc.) and/or audibly (e.g., via a microphone and speech-recognition software) from the candidate 102 via the employment app 104.

The responsibilities interface 800 of the illustrated example facilitates the candidate 102 in selecting responsibilities for the employment title 704 of the candidate 102 at the employer name 702 identified in the position interface 500. As illustrated in FIG. 8, the responsibilities interface 800 includes a prompt 802 instructing the candidate 102 to identify responsibilities of the employment title 704 identified in the position interface 500. Further, the responsibilities interface 800 includes a list of suggested responsibilities 804 that each corresponds with the limited amount of employment information (the employer name 702, the employment title 704, the location 706, and the period of employment defined by the start date 708 and the end date 710) provided by the candidate 102 for the previous position via the position interface 500.

The employment app 104 is configured to present the responsibilities interface 800 with the list of the suggested responsibilities 804 upon the candidate 102 (1) providing the limited amount of employment information via the textboxes of the position interface 500 and (2) subsequently selecting the responsibilities button 720 of the position interface 500. The suggested responsibilities 804 are computer-suggested information that is identified by the entry selector 118 and/or the database manager 114 as being the responsibilities most likely to correspond with the limited amount of employer information provided by the candidate 102 via the position interface 500. Further, the suggested responsibilities 804 are collected by the entry selector 118 in real-time from the responsibilities database 124 based on the limited amount of employment information provided by the candidate 102. In some examples, the suggested responsibilities 804 retrieved by the entry selector 118 in real-time includes a predetermined number of responsibilities that most likely correspond with the limited amount of employment information collected via the position interface 500.

As illustrated in FIG. 8, each of the suggested responsibilities 804 includes a respective checkbox button 806. The checkbox buttons 806 enable the candidate 102 to select responsibilities that the candidate 102 performed for the previous position that was identified via the position interface 500. In the illustrated example, the responsibilities interface 800 is configured to enable the candidate 102 to select none, one, and/or a plurality of responsibilities of the previous position via the checkbox buttons 806. Further, a selected computer-suggested responsibility is identified via a checked box 808, and an unselected computer-suggested responsibility is identified via an unchecked box 810. In some examples, the list of the suggested responsibilities 804 is localized based on the employment location such that the list of the suggested responsibilities 804 corresponds with responsibilities of the identified employment position at the identified employment location to facilitate the candidate 102 in quickly identifying responsibilities for the previous position held by the candidate 102. Further, in some examples, the list of the suggested responsibilities 804 is identified based on the period of employment to facilitate the candidate 102 in quickly identifying responsibilities performed by the candidate 102 during the period of employment.

As illustrated in FIG. 8, the responsibilities interface 800 also includes a textbox 812 that is configured to enable the candidate 102 to enter a responsibility for the previous position. For example, the candidate 102 types a responsibility into the title textbox 604 if the candidate 102 identifies that the responsibility is not included in the list of suggested responsibilities 804. Further, the responsibilities interface 800 also includes an exit button 814 and a submission button 816. In response to the candidate 102 selecting the exit button 814, the app manager 116 exits the responsibilities interface 800 for the candidate 102. For example, the app manager 116 exits the work experience interface 400 by ending a session of the employment app 104 and/or returning to the position interface 500 without saving any selected responsibilities. Further, in response to the candidate 102 selecting the submission button 816 (e.g., identified by text such as “Add to Resume”), the app manager 116 saves the selected responsibilities and the employment app 104 returns to the position interface 500. In the illustrated example, the app manager 116 is configured to receive the selection of one or more of the checkbox buttons 806, the exit button 814, and/or the submission button 816 and/or collect a responsibility via the textbox 812 tactilely (e.g., via a cursor, physical buttons of a keyboard, digital buttons of a touchscreen, etc.) and/or audibly (e.g., via a microphone and speech-recognition software) from the candidate 102 via the employment app 104.

FIG. 9 depicts the work experience interface 400 of the employment app 104 after the candidate 102 has provided work experience information for a list of previous positions held by the candidate 102. As illustrated in FIG. 9, the work experience interface 900 includes a position summary 902 (e.g., a first position summary), another position summary 904 (e.g., a second position summary), and another position summary 906 (e.g., a third position summary). Each of the position summaries 902, 904, 906 include a summary of work experience information (e.g., employment title, employer name, location, period of employment, one or more responsibilities, etc.) corresponding to a previous position of employment of the employer.

The app manager 116 generates a position summary of a previous position of employment for the work experience interface 400 upon collecting the corresponding work experience information via the position interface 500, the title interface 600, and/or the responsibilities interface 800. For example, upon the candidate 102 selecting the add button 404 of the work experience interface 400, the app manager 116 collects work experience information for a first position of employment via the position interface 500, the title interface 600, and/or the responsibilities interface 800. After the candidate 102 selects the save button 714 of the position interface 500 for the first position of employment, the employment app 104 returns to the work experience interface 400 that now includes the position summary 902. In response to the candidate 102 again selecting the add button 404 of work experience interface 400, the app manager 116 collects work experience information for a second position of employment via the position interface 500, the title interface 600, and/or the responsibilities interface 800. After the candidate 102 selects the save button 714 of the position interface 500 for the second position of employment, the employment app 104 returns to the work experience interface 400 that now includes the position summaries 902, 904. In response to the candidate 102 yet again selecting the add button 404 of work experience interface 400, the app manager 116 collects work experience information for a third position of employment via the position interface 500, the title interface 600, and/or the responsibilities interface 800. After the candidate 102 selects the save button 714 of the position interface 500 for the third position of employment, the employment app 104 returns to the work experience interface 400 that now includes the position summaries 902, 904, 906.

In other words, the app manager 116 (1) presents the position interface 500, the title interface 600, and/or the responsibilities interface 800 a first time to collect employment information for a first of previous positions; (2) subsequently presents the position interface 500, the title interface 600, and/or the responsibilities interface 800 a second time to collect employment information for a second of previous positions; and (3) subsequently presents the position interface 500, the title interface 600, and/or the responsibilities interface 800 a third time to collect employment information for a third of previous positions.

Each of the position summaries 902, 904, 906 of the illustrated example includes a delete button 908 that enables the candidate 102 to delete the position summary and the corresponding work experience information. The delete button 908 is represented by a garbage can to facilitate identification by the candidate 102. In response to the candidate 102 selecting the delete button 908, the app manager 116 deletes the corresponding position summary and work experience information. For example, the deleted employment information for the previous position of employment is not included in the resume generated for the candidate 102.

In FIG. 9, the work experience interface 400 also includes an exit button 910 and a submission button 912. In response to the candidate 102 selecting the exit button 910, the app manager 116 exits the work experience interface 400 for the candidate 102. For example, the app manager 116 exits the work experience interface 400 by ending a session of the employment app 104 and/or returning to a previous interface of the employment app 104 (e.g., the contact information interface 300). Further, in response to the candidate 102 selecting the submission button 912 (e.g., identified by text such as “Next: Education”), the app manager 116 saves the collected work experience information and the employment app 104 presents the education interface 1000 to the candidate 102. In the illustrated example, the app manager 116 is configured to receive selection of the add button 404, one or more of the delete buttons 908, the exit button 910, and/or the submission button 912 tactilely (e.g., via a cursor, physical buttons of a keyboard, digital buttons of a touchscreen, etc.) and/or audibly (e.g., via a microphone and speech-recognition software) from the candidate 102 via the employment app 104.

As illustrated in FIG. 10A, the education interface 1000 includes a series of textboxes that enable the candidate 102 to quickly provide and the app manager 116 to receive education information of the candidate 102. For example, the contact information interface 300 includes an education level textbox 1002 (also referred to as a level of education textbox), a school name textbox 1004, a degree textbox 1006, a field-of-study textbox 1008, a start year textbox 1010, and an end year textbox 1012. The education level textbox 1002 enables the candidate 102 to enter an education level 1014 (e.g., “College”) for a particular degree of the candidate 102, the school name textbox 1004 enables the candidate 102 to enter a school name (e.g., LSU) for a particular degree of the candidate 102, and the degree textbox 1006 enables the candidate 102 to enter a degree 1018 (e.g., “Bachelor's Degree”) earned by the candidate 102. Further, the field-of-study textbox 1008 enables the candidate 102 to enter a field-of-study 1020 (e.g., “Human Resources”) that corresponds with the degree 1018 earned by the candidate 102.

In the illustrated example, the employment app 104 also includes a field-of-study interface 1050 that includes a list of suggested fields-of-study 1052 identified (e.g., by the entry selector 118 within a database) in real-time based on the education level 1014, the school name 1016, and/or the degree 1018. The list of the suggested fields-of-study 1052 facilitate the app manager 116 in collecting a field-of-study form the candidate 102 that corresponds with the education level 1014, the school name 1016, and/or the degree 1018. For example, the employment app 104 presents the suggested fields-of-study 1052 to ensure that the candidate 102 identifies a field-of-study is offered at the school name 1016.

Further, the start year textbox 1010 and the end year textbox 1012 enable the candidate 102 to enter a period of education for the degree 1018 of the candidate 102. For example, the start year textbox 1010 enables the candidate 102 to enter a start year 1022 for studying for the degree 1018, and the end year textbox 1012 enables the candidate 102 to enter an end year 1024 for studying for the degree 1018.

The education interface 1000 of the illustrated example also includes a digital toggle 1026 that enables the candidate 102 to identify whether the candidate 102 is currently pursuing the degree 1018 at the school name 1016. The digital toggle 1026 has an inactive position (e.g., a leftward position) and an active position (e.g., a rightward position). If the candidate 102 is currently studying at the school name 1016 to obtain the degree 1018 in the field-of-study 1020, the candidate 102 selects the digital toggle 1026 to cause the digital toggle 1026 to be in the active position. When the digital toggle 1026 is in the active position, the app manager 116 identifies the end year 1024 as “Present” in the end year textbox 1012. In contrast, if the candidate 102 has already obtained the degree 1018 in the field-of-study 1020 at the school name 1016, the candidate 102 selects the digital toggle 1026 to cause the digital toggle 1026 to be in the inactive position. When the digital toggle 1026 is in the inactive position, the app manager 116 enables the candidate 102 to provide the end year 1024 into the end year textbox 1012. In some examples, the digital toggle 1026 is color-coded. For example, a portion of the digital toggle 1026 is grey when in the inactive position, and a portion of the digital toggle 1026 is blue when in the active position.

In the illustrated example, the education interface 1000 also includes a save button 1028 and a cancel button 1030. In response to the candidate 102 selecting the save button 1028, the app manager 116 saves any new and/or updated education information that the candidate 102 has provided via the education interface 1000. Further, the cancel button 1030 is represented by an ‘x’ to facilitate identification by the candidate 102. In response to the candidate 102 selecting the cancel button 1030, the employment app 104 does not save any new and/or updated employment information collected from the candidate 102. For example, the unsaved employment information is not included in the resume generated for the candidate 102.

In some examples, upon the candidate selecting the save button 1028 and/or the cancel button 1030, the employment app 104 returns to a degree interface. For example, the degree interface is substantially similar to the work experience interface 400 in that the degree interface includes (1) an add button that enables the candidate 102 to add education information via the education interface 1000, (2) one or more education summaries that include summary information of the education of the candidate 102, (3) one or more delete buttons that enable the candidate 102 to selectively delete education information, and (4) a submission button that causes the app manager 116 to save the collected education information and the employment app 104 to present the resume interface 1100 to the candidate 102.

In the illustrated example, the app manager 116 is configured to receive the education information and/or a selection of the digital toggle 1026, the save button 1028, the cancel button 1030, and/or the delete button 1032 tactilely (e.g., via a cursor, physical buttons of a keyboard, digital buttons of a touchscreen, etc.) and/or audibly (e.g., via a microphone and speech-recognition software) from the candidate 102 via the employment app 104.

Additionally or alternatively, the employment app 104 includes one or more other interfaces to collect additional type(s) of information utilized by the resume/posting generator 120 to create a resume for the candidate 102. For example, the employment app 104 may include a skills interface to collect relevant skill set(s) from the candidate 102, a license interface to collect occupational license(s) held by the candidate 102, an interest interface to collect outside interest(s) of the candidate 102, etc.

As illustrated in FIG. 11, the resume interface 1100 includes a resume 1102 created by the resume/posting generator 120 (e.g., in real-time) based on the contact information, work experience information, and/or education information collected by other interfaces of the employment app 104. The resume interface 1100 includes the resume 1102 to enable the candidate 102 to review the resume 1102 created by the resume/posting generator 120 on behalf of the candidate 102. For example, the resume/posting generator 120 formats the resume 1102 into a pdf document and/or a word processing document in a standard paper size such that the resume 1102 is attractive to and easily processed by potential employers.

The resume interface 1100 of FIG. 11 also includes a prompt 1104 that instructs the candidate 102 to review and confirm the accuracy of the resume 1102 created by the resume/posting generator 120. For example, the prompt 1104 includes “Confirm your input below” and/or “Below is the resume PDF. If you still need to make changes, you can go back to edit.” Further, the resume interface 1100 of the illustrated example includes a submission button 1106, a digital toggle 1108, and an exit button 1110. The app manager 116 is configured to receive a selection of the submission button 1106, the digital toggle 1108, and/or the exit button 1110 tactilely (e.g., via a cursor, physical buttons of a keyboard, digital buttons of a touchscreen, etc.) and/or audibly (e.g., via a microphone and speech-recognition software) from the candidate 102 via the employment app 104.

In response to the candidate 102 selecting the submission button 1106 (e.g., identified with text such as “Save & Apply”), the app manager 116 causes the database manager 114 to save the resume 1102 created by the resume/posting generator 120 for the candidate 102 in the resume database 126. Additionally or alternatively, the resume 1102 is submitted to potential employer(s) on behalf of the candidate 102 upon the candidate 102 selecting the submission button 1106.

The digital toggle 1108 enables the candidate 102 to control whether the resume 1102 is publicly viewable by potential employer(s) and/or recruiter(s) upon being saved. The digital toggle 1108 has an inactive position (e.g., a leftward position) and an active position (e.g., a rightward position). To enable the resume 1102 to be viewable by potential employer(s) and/or recruiter(s) searching for potential candidates(s) via an employment website and/or app of the employment website entity 100, the candidate 102 selects the digital toggle 1108 to cause the digital toggle 1108 to be in the active position. Otherwise, to prevent employer(s) and/or recruiter(s) from being able to view the resume 1102 during searches conducted on the employment website and/or app, the candidate 102 selects the digital toggle 1108 to cause the digital toggle 1108 to be in the inactive position. In some examples, the digital toggle 1108 is set in the active position as a default to facilitate the candidate 102 in finding employment. Further, in some examples, the digital toggle 1108 is color-coded. For example, a portion of the digital toggle 1108 is grey when in the inactive position, and a portion of the digital toggle 1108 is blue when in the active position.

In response to the candidate 102 selecting the exit button 1110, the app manager 116 exits the resume interface 1100 for the candidate 102. In some examples, the app manager 116 exits the resume interface 1100 by returning to a previous interface of the employment app 104 (e.g., the contact information interface 300, the work experience interface 400, the education interface 1000) to enable the candidate to modify information for the resume 1102. In other examples, the app manager 116 exits the resume interface 1100 by ending a session of the employment app 104.

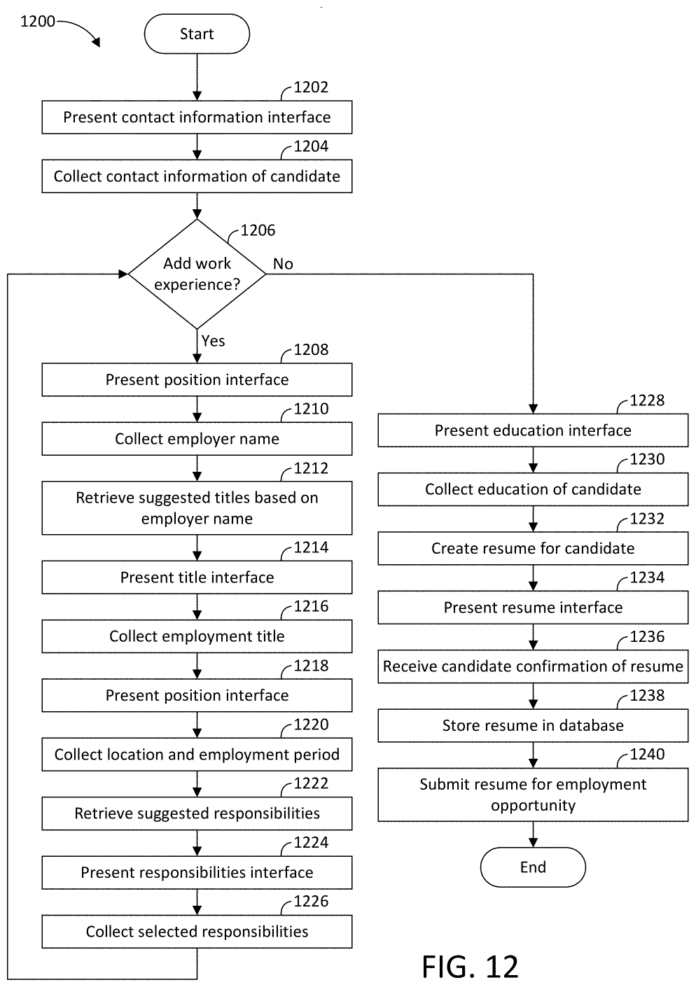

FIG. 12 is a flowchart of an example method 1200 to create a resume for a candidate based on limited candidate-generated information. The flowchart of FIG. 12 is representative of machine readable instructions that are stored in memory (such as the memory 204 of FIG. 2) and include one or more programs which, when executed by one or more processors (such as the processor(s) 202 of FIG. 2), cause the employment website entity 100 to implement the example database manager 114, the example app manager 116, the example entry selector 118, and/or the example resume/posting generator 120 of FIGS. 1 and 2. While the example program is described with reference to the flowchart illustrated in FIG. 12, many other methods of implementing the example database manager 114, the example app manager 116, the example entry selector 118, and/or the example resume/posting generator 120 may alternatively be used. For example, the order of execution of the blocks may be rearranged, changed, eliminated, and/or combined to perform the method 1200. Further, because the method 1200 is disclosed in connection with the components of FIGS. 1-11, some functions of those components will not be described in detail below.

Initially, at block 1202, the app manager 116 presents the contact information interface 300 of the employment app 104 to the candidate 102. At block 1204, the app manager 116 collects contact information of the candidate 102 via the contact information interface 300. For example, the app manager 116 collects the name 314 via the name textbox 304, a location via the city textbox 306 and the state textbox 308, the email address 316 via the email address textbox 310, and the phone number 318 via the phone number textbox 312.

At block 1206 the app manager 116 determines whether to collect additional work experience information of the candidate 102 via the employment app 104. For example, the app manager 116 determines that additional work experience information is to be collected when the candidate 102 selects the add button 404 of the work experience interface 400 of the employment app 104. In response to the app manager 116 determining that additional work experience information of the candidate 102 is to be collected, the method 1200 proceeds to block 1208.

At block 1208, the app manager 116 presents the position interface 500 of the employment app 104 to the candidate 102 to collect work experience information for a previous position held by the candidate 102. At block 1210, the app manager 116 collects the employer name 702 for the previous position from the candidate 102 via the position interface 500. For example, the app manager 116 collects the employer name 702 collects via the employer name textbox 502 of the position interface 500.

At block 1212, the entry selector 118 retrieves the suggested employment titles 602 based on the employer name 702 collected at block 1210. For example, the entry selector 118 retrieves the suggested employment titles 602 in response to the app manager 116 (i) collecting the employer name 702 via the employer name textbox 502 and (ii) subsequently identifying that the candidate 102 has selected the employer name textbox 502 of the position interface 500. At block 1214, the app manager 116 presents the title interface 600 that includes the suggested employment titles 602 to facilitate the candidate 102 in identifying the employment title 704 of the previous position. At block 1216, the app manager 116 collects the employment title 704 of the previous position from the candidate 102. For example, the app manager 116 collects the employment title 704 upon the candidate 102 (i) selecting one of the suggested employment titles 602 or (ii) entering the employment title 704 via the title textbox 604 of the title interface 600.

At block 1218, the app manager 116 presents the position interface 500 to collect additional work experience information for the previous position held by the candidate 102. At block 1220, the app manager 116 collects the location 706, the period of employment, and/or other additional work experience information for the previous position from the candidate 102. For example, the app manager 116 collects the location 706 via the location textbox 506 of the position interface 500 and collects the period of employment via the start date textbox 508 and the end date textbox 510 of the position interface 500.

At block 1222, the entry selector 118 retrieves the suggested responsibilities 804 based on the limited amount of work experience information (e.g., the employer name 702, the employment title 704, the location 706, the period of employment) collected via the employment app 104. For example, the entry selector 118 retrieves the suggested responsibilities 804 in response to the app manager 116 (i) collecting the work experience information via the position interface 500 and/or the title interface 600 and (ii) subsequently identifying that the candidate 102 has selected the responsibilities button 720 of the position interface 500. At block 1224, the app manager 116 presents the responsibilities interface 800 that includes the suggested responsibilities 804 to facilitate the candidate 102 in identifying responsibilities performed by the candidate 102 for the previous position. At block 1226, the app manager 116 collects one or more selected responsibilities from the candidate 102 that the candidate 102 identifies as performing for the previous position. For example, the app manager 116 collects the one or more selected responsibilities upon the candidate 102 (i) selecting one or more of the checkbox buttons 806 of the suggested responsibilities 804 and/or (ii) entering one or more of the selected responsibilities via the textbox 812 of the responsibilities interface 800.

Upon returning to block 1206, the app manager 116 again determines whether to collect additional work experience information of the candidate 102. In response to the app manager 116 determining that additional work experience information is to be collected, the method 1200 repeats blocks 1208, 1210, 1212, 1214, 1216, 1218, 1220, 1222, 1224, 1226. Otherwise, in response to the app manager 116 determining that additional work experience information is not to be collected, the method 1200 proceeds to block 1228.

At block 1228, the app manager 116 presents the education interface 1000 to collect education information of the candidate 102. At block 1230, the app manager 116 collects the education information from the candidate 102. For example, the app manager 116 collects the education level 1014 via the education level textbox 1002, the school name 1016 via the school name textbox 1004, the degree 1018 via the degree textbox 1006, the field-of-study 1020 via the field-of-study textbox 1008, and the period of education via the start year textbox 1010 and the end year textbox 1012.

At block 1232, the resume/posting generator 120 creates the resume 1102 for the candidate 102 based upon the collected information. For example, the resume/posting generator 120 creates the resume 1102 as a pdf document and/or a word processing document in a standard paper size. At block 1234, the app manager 116 presents the resume interface 1100 to the candidate 102. The resume interface 1100 includes the resume 1102 and the submission button 1106. At block 1236, the app manager 116 receives confirmation of the resume 1102 from the candidate 102. For example, upon reviewing the resume 1102 and determining that the resume 1102 is an accurate representation, the candidate 102 selects the submission button 1106 to indicate that the candidate 102 approves of the resume 1102 generated by the resume/posting generator 120. At block 1238, the database manager 114 stores the resume 1102 of the candidate 102 in the resume database 126. In some examples, the app manager 116 updates the resume 1102 stored in the resume database 126 over time to account change(s) to information included in the resume 1102 (e.g., modernizing a characterization of a responsibility, modernizing an employment title, accounting for a change in the employer name, etc.). At block 1240, the app manager 116 submits the resume 1102 of the candidate 102 to an employer for a potential employment opportunity. For example, the app manager 116 causes the database manager 114 to retrieve the resume 1102 from the resume database 126 to enable the app manager 116 to submit the resume 1102 on behalf of the candidate 102.

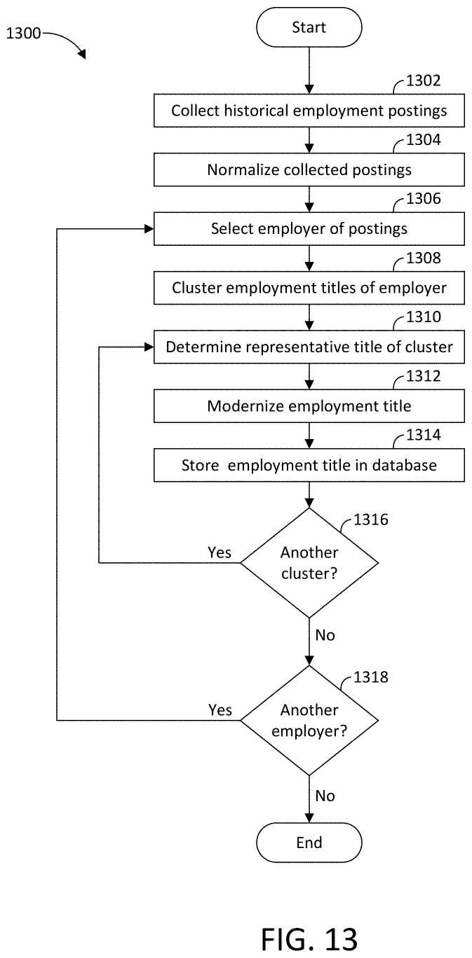

FIG. 13 is a flowchart of an example method 1300 to generate a database with position titles of employers. The flowchart of FIG. 13 is representative of machine readable instructions that are stored in memory (such as the memory 204 of FIG. 2) and include one or more programs which, when executed by one or more processors (such as the processor(s) 202 of FIG. 2), cause the employment website entity 100 to implement the example database manager 114 of FIGS. 1 and 2. While the example program is described with reference to the flowchart illustrated in FIG. 13, many other methods of implementing the example database manager 114 may alternatively be used. For example, the order of execution of the blocks may be rearranged, changed, eliminated, and/or combined to perform the method 1300. Further, because the method 1300 is disclosed in connection with the components of FIGS. 1-2, some functions of those components will not be described in detail below.

Initially, at block 1302, the database manager 114 collects historical employment postings from the network 112. For example, the database manager 114 collects employment postings previously posted via the employment app 142, another employment app and/or website of the employment website entity 100, and/or other website(s) with employment postings. In some examples, the database manager 114 performs web scraping to extract information for the historical employment postings one or more internal networks (e.g., a network of the employment website entity 100) and/or external networks (e.g., the Internet). Further, in some examples, the database manager 114 utilizes text mining software to identify pieces of information, such as the employer and the employment title, within the collected historical postings. At block 1304, the database manager 114 normalizes and/or cleans the collected postings to remove unrelated noise from the collected postings.

At block 1306, the database manager 114 selects one of the employers of the collected postings. At block 1308, the database manager 114 clusters together employment titles of the employer within the collected postings (e.g., utilizing hierarchical clustering, k-means clustering, nearest neighbor classifications, etc.). For example, the database manager 114 clusters together sets of the employment titles included within the collected postings of the employer based on the degree of similarity between the employment titles. At block 1310, the database manager 114 selects one of the clusters and determines a representative title of the cluster. In some examples, the database manager 114 selects one of the employment titles within the cluster as the representative title. At block 1312, the database manager 114 modernizes the representative title to create an employment title for the selected cluster. For example, the database manager 114 modernizes the employment title to facilitate the resume/posting generator 120 in creating (i) a resume that is attractive to current employers for current employment positions (ii) a job posting that is attractive to potential candidates. At block 1314, the database manager 114 stores the employment title of the employer within the employer-title database 122.

At block 1316, the database manager 114 determines whether there is another cluster of the employer selected at block 1306. In response to the database manager 114 determining that there is another cluster, the method 1300 returns to block 1310 to repeat blocks 1310, 1312, 1314, 1316 until no other cluster of the selected employer is identified. Otherwise, in response to the database manager 114 determining that there is not another cluster, the method 1300 proceeds to block 1318.

At block 1318, the database manager 114 determines whether there is another employer identified within the postings collected at block 1302. In response to the database manager 114 determining that there is another employer, the method 1300 returns to block 1306 to repeat blocks 1306, 1308, 1310, 1312, 1314, 1316, 1318 until no other employer of the collected postings is identified. Otherwise, in response to the database manager 114 determining that there is not another employer, the method 1300 ends.

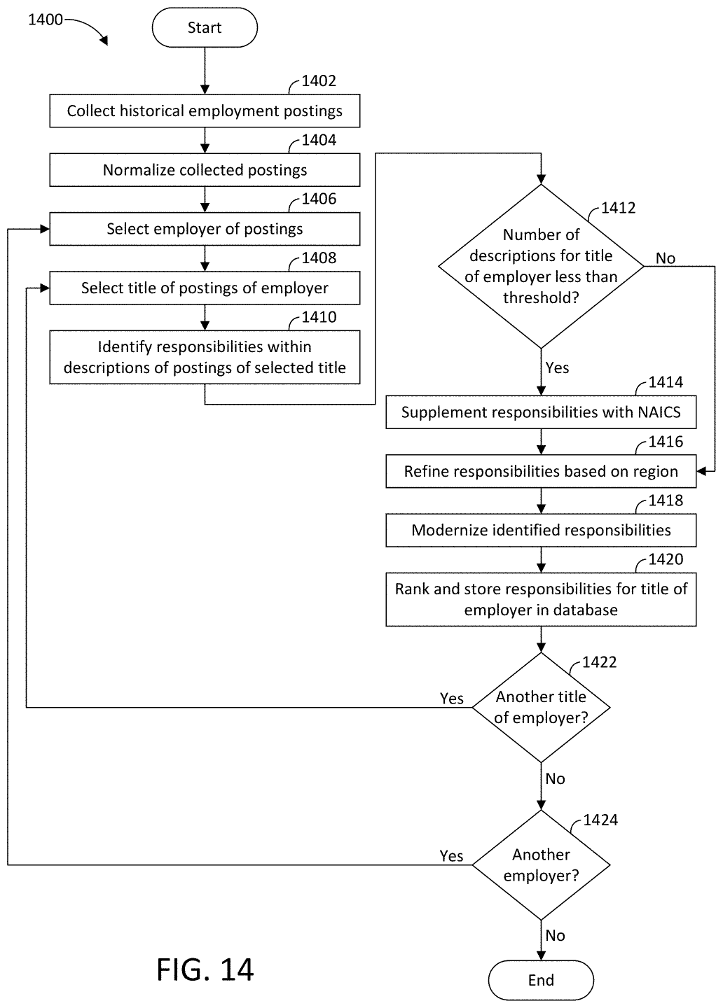

FIG. 14 is a flowchart of an example method 1400 to generate a database with suggested responsibilities for position titles of employers. The flowchart of FIG. 14 is representative of machine readable instructions that are stored in memory (such as the memory 204 of FIG. 2) and include one or more programs which, when executed by one or more processors (such as the processor(s) 202 of FIG. 2), cause the employment website entity 100 to implement the example database manager 114 of FIGS. 1 and 2. While the example program is described with reference to the flowchart illustrated in FIG. 14, many other methods of implementing the example database manager 114 may alternatively be used. For example, the order of execution of the blocks may be rearranged, changed, eliminated, and/or combined to perform the method 1400. Further, because the method 1400 is disclosed in connection with the components of FIGS. 1-2, some functions of those components will not be described in detail below.

Initially, at block 1402, the database manager 114 collects historical employment postings from the network 112. For example, the database manager 114 collects employment postings previously posted via the employment app 142, another employment app and/or website of the employment website entity 100, and/or other website(s) with employment postings. In some examples, the database manager 114 performs web scraping to extract information for the historical employment postings one or more internal networks (e.g., a network of the employment website entity 100) and/or external networks (e.g., the Internet). Further, in some examples, the database manager 114 utilizes text mining software to identify pieces of information, such as the employer, the employment title, and job responsibilities, within the collected historical postings. At block 1404, the database manager 114 normalizes and/or cleans the collected postings to remove unrelated noise from the collected postings.

At block 1406, the database manager 114 selects one of the employers of the collected postings. Further, at block 1408, the database manager 114 selects one of the employment titles within the collected historical postings of the selected employer. At block 1410, the database manager 114 identifies each of the responsibilities of the selected title within descriptions of the postings for the selected title of the selected employer. For example, the database manager 114 utilizes parts-of-speech (POS) tags, dependency parse trees, and/or other text recognition algorithms to identify the responsibilities within the descriptions of the postings.

At block 1412, the database manager 114 determines whether the number of identified descriptions of postings for the selected title of the selected employer is less than a predetermined threshold. For example, the predetermined threshold corresponds with a number of descriptions of postings that enables the database manager 114 to consistently identify an accurate list of responsibilities associated with the selected title of the selected employer. In response to the database manager 114 determining that the number of identified descriptions is not less than the predetermined threshold, the method 1400 proceeds to block 1416. Otherwise, in response to the database manager 114 determining that the number of identified descriptions is less than the predetermined threshold, the method 1400 proceeds to block 1414 at which the database manager 114 supplements the responsibilities identified with the postings with information included in an industry classification system for the employment title of the postings.

At block 1416, the database manager 114 refines the identified responsibilities based upon the geographic regions that correspond to the selected title of the selected employer to account for differences of responsibilities of the same position within different geographic regions. For example, the database manager 114 localizes the responsibilities such that a first set of responsibilities correspond with the selected title of the selected employer in a first geographic region and a second set of responsibilities correspond with the selected title of the selected employer in a second geographic region. At block 1418, the database manager 114 modernizes the identified responsibilities to account for re-characterizations of responsibilities over time. For example, the database manager 114 updates how the identified responsibilities are described to facilitate the resume/posting generator 120 in creating (i) a resume that is attractive to current employers for current employment positions and/or (ii) a job posting that is attractive to potential candidates. At block 1420, the database manager 114 ranks and stores the responsibilities (e.g., the localized and/or modernized responsibilities) for the selected title of the selected employer within the responsibilities database 124.

At block 1422, the database manager 114 determines whether there is another employment title of the employer selected at block 1406. In response to the database manager 114 determining that there is another employment title, the method 1400 returns to block 1408 to repeat blocks 1408, 1410, 1412, 1414, 1416, 1418, 1420, 1422 until no other employment title of the selected employer is identified. Otherwise, in response to the database manager 114 determining that there is not another employment title, the method 1400 proceeds to block 1424.

At block 1424, the database manager 114 determines whether there is another employer identified within the postings collected at block 1402.

In response to the database manager 114 determining that there is another employer, the method 1400 returns to block 1406 to repeat blocks 1406, 1408, 1410, 1412, 1414, 1416, 1418, 1420, 1422 until no other employer of the collected postings is identified. Otherwise, in response to the database manager 114 determining that there is not another employer, the method 1400 ends.

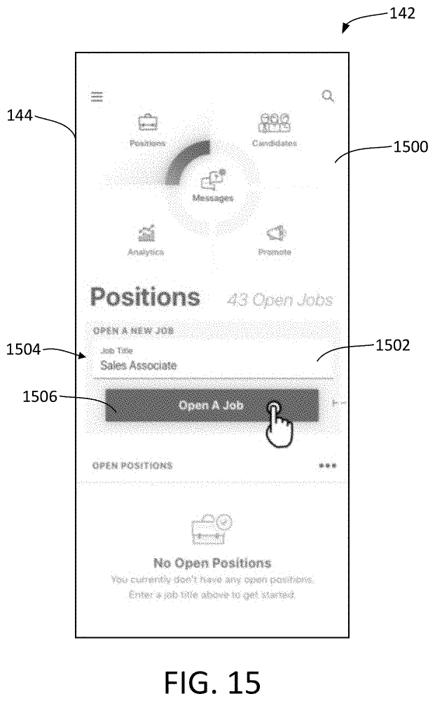

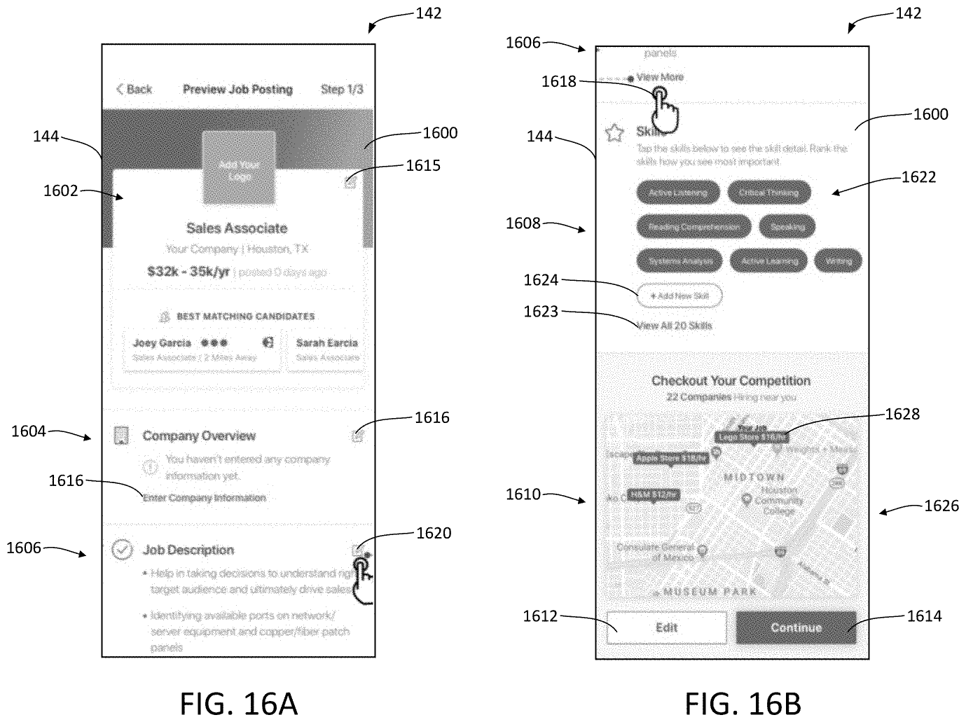

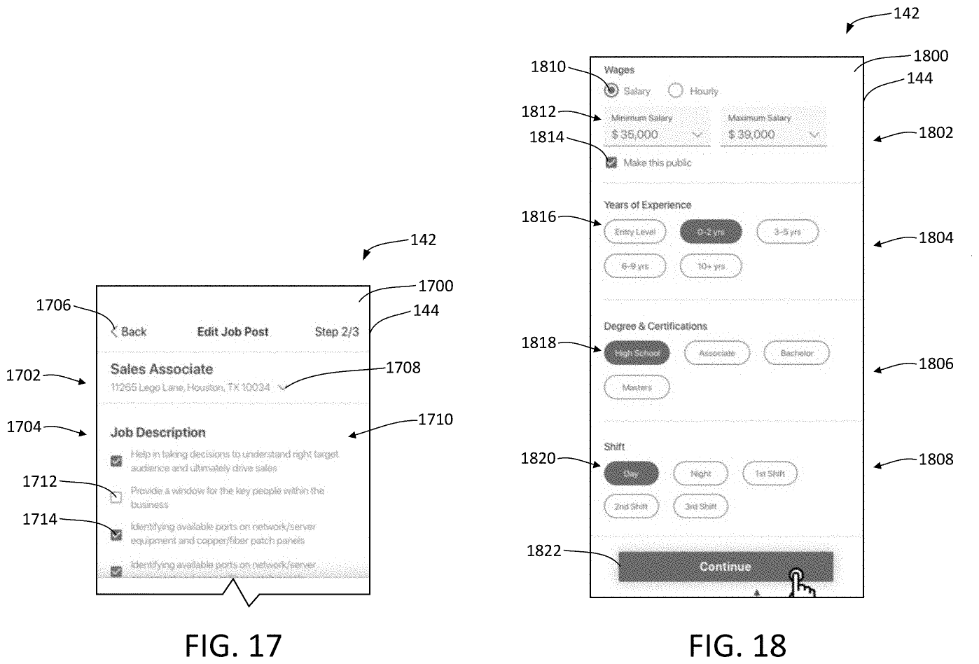

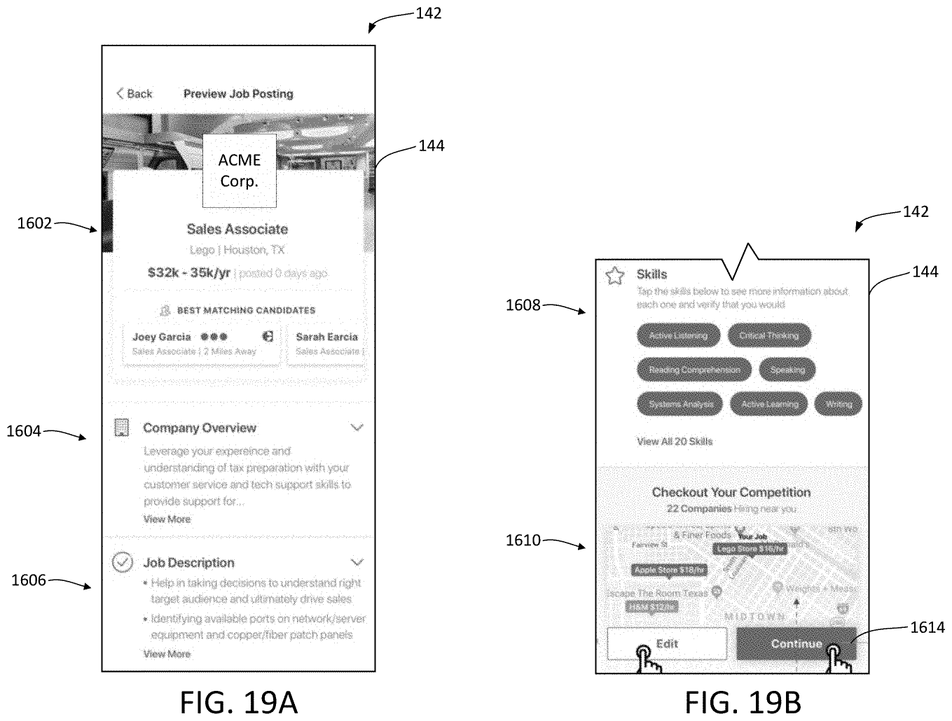

FIGS. 15-19B depict example interfaces of the employment app 142. The example interfaces are configured to be presented via the touchscreen 144 of the mobile device 146 and/or other display(s) of other computing device(s). The interfaces are particularly structured, individually and in conjunction with each other, to collect and present resume-related information in an easy-to-follow manner that enables the recruiter 140 to conveniently utilize the mobile device 146 and/or another computing device for quickly creating an attractive job posting for the recruiter 140. That is, the employment app 142 includes a plurality of interfaces configured to facilitate the app manager 116 in quickly collecting information from the recruiter 140. In particular, FIG. 15 depicts an example title interface 1500, FIGS. 16A-16B depict an example preview interface 1600 in a first state, FIG. 17 depicts a portion of an example responsibilities interface 1700, FIG. 18 depicts an example position interface 1800, and FIGS. 19A-19B depict the example preview interface 1600 in a second state.

As illustrated in FIG. 15, the title interface 1500 of the employment app 142 is initially presented to the recruiter 140 to enable the app manager 116 to receive a job title for an employment position from the recruiter 140. The title interface 1500 includes a textbox 1502 that enables the recruiter 140 to quickly enter a job title 1504 for the employment position of the job posting. In some examples, the title interface 1500 is configured to collect other information, such as a job location and/or employer name, from the recruiter 140. For example, the title interface 1500 may include a respective textbox for each respective type of information to be collected. Further, the app manager 116 is configured to receive the job title 1504 and/or other recruiter-generated information textually (e.g., via a cursor, physical buttons of a keyboard, digital buttons of a touchscreen, etc.) and/or audibly (e.g., via a microphone and speech-recognition software) from the recruiter 140 via the employment app 142. In the illustrated example, the title interface 1500 also includes a start button 1506 (e.g., labeled as “Open A Job” in FIG. 15). The app manager 116 is configured to receive a selection of the add button 404 tactilely (e.g., via a cursor, physical buttons of a keyboard, digital buttons of a touchscreen, etc.) and/or audibly (e.g., via a microphone and speech-recognition software) from the recruiter 140 via the employment app 142. In response to the recruiter 140 selecting the start button 1506, (i) the app manager 116 saves the collected job title and/or other information and (ii) the employment app 142 presents the preview interface 1600 to collect additional information for the job posting from the recruiter 140.

As illustrated in FIGS. 16A and 16B, the preview interface 1600 enables the recruiter 140 to preview the job posting that is to be generated. In the illustrated example, the preview interface 1600 includes a summary section 1602, an employer section 1604, a responsibilities section 1606, a skills section 1608, a location section 1610, an edit button 1612, and a continue button 1614.

In the illustrated example, the summary section 1602 is configured to include a brief description of the employment position. For example, the summary section 1602 is configured to include the job title, a job location, an employer name, an income level, etc. Further, the summary section 1602 includes an edit button 1615 to enable the recruiter 140 to edit the information of the summary section 1602. For example, upon receiving a selection of the edit button 1615 from the recruiter 140, the app manager 116 presents a summary interface that enables the recruiter 140 to provide the corresponding information via the employment app 142. Further, the employer section 1604 is configured to include more detailed information regarding the employer for the employment position. The employer section 1604 includes an edit button 1616 to enable the recruiter 140 to edit the information of the employer section 1604. For example, upon receiving a selection of the edit button 1616 from the recruiter 140, the app manager 116 presents an employer interface that enables the recruiter 140 to provide the corresponding information via the employment app 142.

The responsibilities section 1606 is configured to include a list of responsibilities for the employment position of the job posting. In the illustrated example, the preview interface 1600 includes only a portion of the responsibilities corresponding with the employment position. The responsibilities section 1606 includes an expand button 1618 (also referred to as a “view more” button) that enables the recruiter 140 to view more of the responsibilities corresponding with the employment position. That is, the app manager 116 causes the preview interface 1600 to present more of the responsibilities in response to the recruiter 140 selecting the expand button 1618. Further, the responsibilities section 1606 includes an edit button 1620 to enable the recruiter 140 to edit the information of the responsibilities section 1606. For example, upon receiving a selection of the edit button 1620 from the recruiter 140, the app manager 116 presents a responsibility interface (e.g., the responsibilities interface 1700 of FIG. 17) that enables the recruiter 140 to select one or more computer-suggested responsibilities for the employment position.

The skills section 1608 is configured to include a list of preferred skills for the employment position of the job posting. In the illustrated example, the preview interface 1600 includes only a portion of the skills corresponding with the employment position. The skills section 1608 includes an expand button 1623 that enables the recruiter 140 to view more, if not all, of the skills corresponding with the employment position. That is, the app manager 116 causes the preview interface 1600 to present more of the skills in response to the recruiter 140 selecting the expand button 1623. The skills section 1608 also includes an edit button 1624 to enable the recruiter 140 to edit the information of the skills section 1608. For example, upon receiving a selection of the edit button 1624 from the recruiter 140, the app manager 116 presents a skills interface that enables the recruiter 140 to select one or more computer-suggested skills for the employment position.

The location section 1610 of the illustrated example includes a map 1626 that enables the recruiter 140 to view the location of the employment position relative to other nearby employment locations. For example, the map 1626 includes a pin 1628 that identifies the location of the employment position and other pins that identify the nearby locations of other similar positions. Additionally, in the illustrated example, each of the pins (e.g., including the pin 1628) includes wage information to facilitate the recruiter 140 in comparing the wages of nearby similar positions. Additionally, when the recruiter 140 selects the edit button 1612, the app manager 116 enables the recruiter 140 to edit information for one or more sections of the preview interface 1600 and/or the job posting. When the recruiter 140 selects the continue button 1614, the app manager 116 instructs the resume/posting generator 120 to create the job posting based on the collected information.

Additionally, the app manager 116 is configured to receive the selection of one or more of the buttons of the preview interface 1600 tactilely (e.g., via a cursor, physical buttons of a keyboard, digital buttons of a touchscreen, etc.) and/or audibly (e.g., via a microphone and speech-recognition software) from the recruiter 140 via the employment app 142.

The responsibilities interface 1700 of FIG. 17 facilitates the recruiter 140 in selecting responsibilities for the job title 1504. The responsibilities interface 1700 of the illustrated example includes a summary section 1702, a responsibilities section 1704, and a back button 1706. In response to the recruiter 140 selecting the back button 1706, the app manager 116 exits the responsibilities interface 1700 and returns to the preview interface 1600. In the illustrated example, the summary section 1702 includes a brief summary of the job position (e.g., a job title and a location). The summary section 1702 also includes an expand button 1708. In response to the recruiter 140 selecting the expand button 1708, the app manager 116 expands the summary section 1702 within the responsibilities interface 1700 to present additional information about the job position.

As illustrated in FIG. 17, the responsibilities section 1704 includes a list of suggested responsibilities 1710 that correspond with the limited amount of information (the job title 1504, a job location, an employer name) previously provided by the recruiter 140. In the illustrated example, the list of suggested responsibilities 1710 includes the following: “Help in taking decisions to understand right target audience and ultimately drive sales,” “Provide a window for the key people within the business,” “Identifying available ports on network/server equipment and copper/fiber patch panels,” etc. The suggested responsibilities are computer-suggested information that is identified by the entry selector 118 and/or the database manager 114 as being the responsibilities most likely to correspond with the limited amount of job posting information collected from the recruiter 140. Further, the suggested responsibilities are collected by the entry selector 118 in real-time from the responsibilities database 124 based on the limited amount of information provided by the recruiter 140. In some examples, the suggested responsibilities retrieved by the entry selector 118 in real-time includes a predetermined number of responsibilities that most likely correspond with the limited amount of collected information.

Further, as illustrated in FIG. 17, the responsibilities section 1704 includes a checkbox button for each of the suggested responsibilities. The checkbox buttons enable the recruiter 140 to select responsibilities that correspond with the job position of the posting. The responsibilities interface 1700 is configured to enable the recruiter 140 to select none, one, and/or a plurality of responsibilities of the previous position via the checkbox buttons. In the illustrated example, an unselected computer-suggested responsibility is identified via an unchecked box 1712, and a selected computer-suggested responsibility is identified via a checked box 1714. In some examples, the list of suggested responsibilities 1710 is localized based on the location of the position such that the list of suggested responsibilities 1710 corresponds with responsibilities of the identified employment position at the identified employment location to facilitate the recruiter 140 in quickly identifying relevant responsibilities.

Additionally, the app manager 116 is configured to receive the selection of one or more of the buttons of the responsibilities interface 1700 tactilely (e.g., via a cursor, physical buttons of a keyboard, digital buttons of a touchscreen, etc.) and/or audibly (e.g., via a microphone and speech-recognition software) from the recruiter 140 via the employment app 142.

As illustrated in FIG. 18, the position interface 1800 enables the recruiter 140 to select background and/or employment-type information for the job posting. For example, the background information includes preferred years-of-experience, a preferred education level, etc. for potential candidates. Further, the employment-type information includes information related to a wage type, a shift type, an income level, etc. for the employment position. In the illustrated example, the position interface 1800 includes a wages section 1802, an experience section 1804, an education section 1806, and a schedule section 1808.

The wages section 1802 of the illustrated example includes wage-type buttons 1810, income textboxes 1812, and a make-public button 1814. The wage-type buttons 1810 enable the recruiter 140 to select whether the employment position is an hourly or a salary position, the income textboxes 1812 enable the recruiter 140 to select a minimum and/or a maximum hourly- or salary-wage for the employment position, and the make-public button 1814 enables the recruiter 140 to select whether to make the wage information public by including the wage information in the job posting.

In the illustrated example, the experience section 1804 includes buttons 1816 that enable the recruiter 140 to selected a preferred amount of experience for potential candidates. The education section 1806 includes buttons 1818 that enable the recruiter 140 to selected a preferred education level for potential candidates. Further, the schedule section 1808 includes buttons 1820 that enable the recruiter 140 to select a work schedule for the employment position. Additionally, the position interface 1800 includes a continue button 1822. When the recruiter 140 selects the continue button 1822, the app manager 116 saves the information selected within the position interface 1800 and returns to the preview interface 1600.

In some examples, the buttons presented in the position interface 1800 are computer-suggested options that are identified by the entry selector 118 and/or the database manager 114 as being most likely to be relevant for the employment position (e.g., based on the information previously collected from the recruiter 140). Additionally, the app manager 116 is configured to receive the selection of one or more of the buttons of the position interface 1800 tactilely (e.g., via a cursor, physical buttons of a keyboard, digital buttons of a touchscreen, etc.) and/or audibly (e.g., via a microphone and speech-recognition software) from the recruiter 140 via the employment app 142.

FIGS. 19A and 19B illustrate the preview interface 1600 after recruiter-generated information and selected computer-suggested information have been collected by the employment app 142. In particular, the FIGS. 19A and 19B depict the preview interface 1600 after information for the summary section 1602, the employer section 1604, the responsibilities section 1606, the skills section 1608, and the location section 1610 have been collected. Further, the resume/posting generator 120 creates the job posting based upon the collected information in response to the recruiter 140 selecting the continue button 1614.

In some examples, the app manager 116 subsequently presents a posting interface to the recruiter 140 to enable the recruiter 140 to review the job posting before it is posted for candidates to view. For example, the posting interface includes the job posting, an edit button, and a save button. The app manager 116 enables the recruiter 140 to edit the job posting upon selecting the edit button. When the recruiter 140 selects the save button, the app manager 116 receives confirmation from the recruiter 140 that the generated job posting is in a satisfactory condition for posting. That is, upon reviewing the job posting, the candidate 102 selects the save button to indicate that recruiter 140 approves of the job posting generated by the resume/posting generator 120. Additionally, in response to the recruiter 140 selecting the save button, the database manager 114 stores the job posting of the recruiter 140 in the posting database 127 and the app manager 116 presents the job posting of the recruiter 140 to one or more candidates via the employment app 104 for candidates.

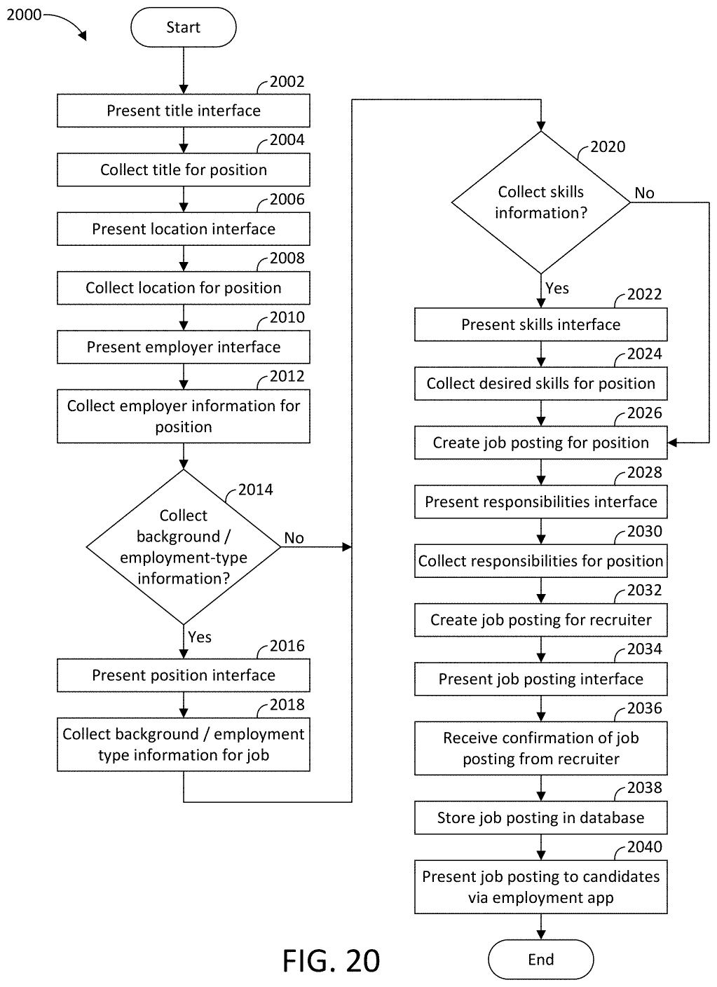

FIG. 20 is a flowchart of an example method 1200 to create a job description and/or posting for an employment position based on limited recruiter-generated information. The flowchart of FIG. 20 is representative of machine readable instructions that are stored in memory (such as the memory 204 of FIG. 2) and include one or more programs which, when executed by one or more processors (such as the processor(s) 202 of FIG. 2), cause the employment website entity 100 to implement the example database manager 114, the example app manager 116, the example entry selector 118, and/or the example resume/posting generator 120 of FIGS. 1 and 2. While the example program is described with reference to the flowchart illustrated in FIG. 20, many other methods of implementing the example database manager 114, the example app manager 116, the example entry selector 118, and/or the example resume/posting generator 120 may alternatively be used. For example, the order of execution of the blocks may be rearranged, changed, eliminated, and/or combined to perform the method 2000. Further, because the method 2000 is disclosed in connection with the components of FIGS. 1-2 and 15-19B, some functions of those components will not be described in detail below.

Initially, at block 2002, the app manager 116 presents the title interface 1500 of the employment app 142 to the recruiter 140. At block 2004, the app manager 116 collects, via the title interface 1500, a job title of an employment position from the recruiter 140. For example, the app manager 116 collects the job title 1504 via the textbox 1502. At block 2006, the app manager 116 presents a location interface of the employment app 142 to the recruiter 140. At block 2008, the app manager 116 collects, via the location interface, a job location of the employment position from the recruiter 140. At block 2010, the app manager 116 presents an employer interface of the employment app 142 to the recruiter 140. At block 2012, the app manager 116 collects, via the employer interface, an employer name associated with the employment position from the recruiter 140.

At block 2014, the app manager 116 determines whether to collect background information and/or employment-type information from the recruiter 140 via the employment app 142. For example, the app manager 116 determines that background information and/or employment-type information is to be collected when the recruiter 140 selects a corresponding button (e.g., the edit button 1620 of the preview interface 1600) of the employment app 142. In response to the app manager 116 determining that background and/or employment-type information is not to be collected, the method 2000 proceeds to block 2020. Otherwise, in response to the app manager 116 determining that background and/or employment-type information is to be collected, the method 2000 proceeds to block 2016 at which the app manager 116 presents the position interface 1800 of the employment app 142 to the recruiter 140. In some examples, the app manager 116 includes lists of computer-suggested and user-selectable background and/or employment-type characteristics in the position interface 1800 based on the job title, the job location, the employer name, and/or other previously provided information. At block 2018, the app manager 116 collects, via the position interface 1800, preferred background information of a candidate (e.g., work experience, education level) and/or employment-type information of the employment position (e.g., wage type, shift, income level) from the recruiter 140.

At block 2020, the app manager 116 determines whether to collect skills information from the recruiter 140 via the employment app 142. For example, the app manager 116 determines that skills information is to be collected when the recruiter 140 selects a corresponding button (e.g., the edit button 1624 of the preview interface 1600) of the employment app 142. In response to the app manager 116 determining that skills information is not to be collected, the method 2000 proceeds to block 2026. Otherwise, in response to the app manager 116 determining that skills information is to be collected, the method 2000 proceeds to block 2022 at which the app manager 116 presents a skills interface of the employment app 142 to the recruiter 140. In some examples, the app manager 116 includes lists of computer-suggested and user-selectable skills in the skills interface based on the job title, the job location, the employer name, and/or other previously provided information. At block 2024, the app manager 116 collects, via the skills interface, preferred skills of a candidate for the employment position.

At block 2028, the app manager 116 presents the responsibilities interface 1700 of the employment app 142 to the recruiter 140. For example, the app manager 116 presents the responsibilities interface 1700 upon detecting that the recruiter 140 has selected a corresponding button (e.g., the edit button 1620 of the preview interface 1600) of the employment app 142. The app manager 116 includes lists of computer-suggested and user-selectable responsibilities in the responsibilities interface 1700 based on the job title, the job location, the employer name, and/or other previously provided information. At block 2030, the app manager 116 collects, via the responsibilities interface 1700, responsibilities that a candidate would perform if hired for the position. For example, the app manager 116 identifies responsibilities that are selected (e.g., via checkbox buttons) by the recruiter 140 from the list of computer-suggested responsibilities.

At block 2032, the resume/posting generator 120 creates a job posting for the employment position associated with the recruiter 140 based upon the collected information. At block 2034, the app manager 116 presents a posting interface to the recruiter 140. The posting interface includes the generated job posting for review, an edit button, and a save button. At block 2036, the app manager 116 receives confirmation of the job posting from the recruiter 140. For example, upon reviewing the job posting, the candidate 102 selects the save button to indicate that recruiter 140 approves of the job posting generated by the resume/posting generator 120. At block 2038, the database manager 114 stores the job posting of the recruiter 140 in the posting database 127. At block 2040, the app manager 116 presents the job posting of the recruiter 140 to one or more candidates via the employment app 104 for candidates. For example, the app manager 116 causes the database manager 114 to retrieve the job posting from the posting database 127 to enable the app manager 116 to present the job posting on behalf of the recruiter 140.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. An automated system for creating resumes for candidates with limited candidate-generated information, the system comprising:
a responsibility database configured to store responsibilities for employment positions of employers; and
one or more processors configured to:
obtain employment information for previous positions of a candidate via an employment app, wherein, to obtain the employment information for each of the previous positions, the one or more processors are configured to:
present a position interface of the employment app to the candidate;
collect an employer name, a position title, a location, and a period of employment for the previous position of the candidate via the position interface;
retrieve suggested responsibilities in real-time from the responsibility database based on the employer name, the position title, the location, and the period of employment;
present a responsibilities interface of the employment app, the responsibilities interface includes the suggested responsibilities identified for the previous position; and
collect, via the responsibilities interface, one or more selected responsibilities that the candidate performed for the previous position; and
create, in real-time, a resume for the candidate utilizing the one or more selected responsibilities to reduce an amount of candidate-generated information from which the resume is created.

2. The system of claim 1, wherein the employment app presented by the one or more processors includes at least one of a mobile app and a mobile-friendly website for a touchscreen of a mobile device.

3. The system of claim 2, wherein the employment app includes a plurality of interfaces including the position interface and the responsibilities interface configured to facilitate the one or more processors in quickly collecting the employment information and the selected responsibilities from the candidate.

4. The system of claim 1, wherein the one or more processors are configured to:
present the position interface and the responsibilities interface a first time to collect the employment information for a first of the previous positions; and
subsequently present the position interface and the responsibilities interface a second time to collect the employment information for a second of the previous positions.

5. The system of claim 1, wherein the one or more processors are configured to:
format the resume into a pdf document in a standard paper size; and
present a resume interface that includes the resume to enable the candidate to review formatting of the resume.

6. The system of claim 1, wherein the one or more processors are further configured to construct the responsibilities database and organize links between the responsibilities and the employment positions of the employers within the responsibilities database.

7. The system of claim 6, wherein, to construct the responsibilities database, the one or more processors are configured to:
collect historical postings from a network;
identify posted titles and posted responsibilities within the historical postings; and
for each of the posted titles:
utilize parts-of-speech tags and dependency parse trees to identify employment responsibilities of the posted title;
in response to determining that the number of historical postings for the posted title is less than a predetermined threshold, supplement the employment responsibilities with information included in an industry classification system for the posted title; and
rank the employments responsibilities of the posted title for relevancy to enable identification of a predetermined number of the highest ranked employments responsibilities as the suggested responsibilities for the posted title.

8. The system of claim 1, wherein the suggested responsibilities stored in the responsibility database are modernized from employment responsibilities of historical postings to facilitate the one or more processors in creating the resume to be targeted for current positions.

9. The system of claim 1, wherein the suggested responsibilities stored in the responsibility database are localized based on employment responsibilities of historical postings for different geographic locations to facilitate the one or more processors in creating the resume for a preferred location of the candidate.

10. The system of claim 1, wherein, upon receiving the employer name for one of the previous positions via the position interface, the one or more processors are configured to present a title interface that includes suggested titles for the employer name.

11. The system of claim 1, further including an employer-title database that stores the employer names and the position titles corresponding with the employer names, wherein, for one or more of the previous positions, the one or more processors are configured to retrieve the suggested titles based on the employer name.

12. An automated system for creating job postings with limited recruiter-generated information, the system comprising:
a responsibility database configured to store responsibilities for employment positions of employers; and
one or more processors configured to:
obtain position information for a posting of a recruiter via an employment app, wherein, to obtain the position information, the one or more processors are configured to:
present a title interface of the employment app to the recruiter;
collect a position title for the posting of the recruiter via the position interface;
retrieve suggested responsibilities in real-time from the responsibility database based on the position title and a location of the posting;
present a responsibilities interface of the employment app, the responsibilities interface includes the suggested responsibilities identified for the posting; and
collect, via the responsibilities interface, one or more selected responsibilities for the posting;
create, in real-time, a job description for the posting utilizing the one or more selected responsibilities to reduce an amount of recruiter-generated information from which the job description for the posting is created.

13. The system of claim 12, wherein the suggested responsibilities stored in the responsibility database are modernized and localized based employment responsibilities of historical postings to facilitate the one or more processors in creating the resume to be targeted for current positions.

14. The system of claim 12, wherein the one or more processors are configured to collect the location for the posting via a location interface of the employment app.

15. The system of claim 14, wherein the one or more processors are configured to collect an employer name for the posting via an employer interface of the employment app and retrieve the suggested responsibilities from the responsibility database further based on the employer name.

16. The system of claim 12, wherein the employment app presented by the one or more processors includes at least one of a mobile app and a mobile-friendly website for a touchscreen of a mobile device to facilitate the one or more processors in quickly collecting the position information and the selected responsibilities from the recruiter.

17. The system of claim 12, wherein the one or more processors are configured to store the job description and the posting in a posting database.

18. The system of claim 12, wherein the one or more processors are configured to present a position interface of the employment app to the recruiter and receive experience and education information for the posting via the position interface, and wherein the one or more processors are configured to create the posting further based on the experience and education information.

19. The system of claim 12, wherein the one or more processors are further configured to construct the responsibilities database and organize links between the responsibilities and the employment positions of the employers within the responsibilities database.

20. The system of claim 19, wherein, to construct the responsibilities database, the one or more processors are configured to:
collect historical postings from a network;
identify posted titles and posted responsibilities within the historical postings; and
for each of the posted titles:
utilize parts-of-speech tags and dependency parse trees to identify employment responsibilities of the posted title;
in response to determining that the number of historical postings for the posted title is less than a predetermined threshold, supplement the employment responsibilities with information included in an industry classification system for the posted title; and
rank the employments responsibilities of the posted title for relevancy to enable identification of a predetermined number of the highest ranked employments responsibilities as the suggested responsibilities for the posted title.
